(19) United States
(12) Patent Application Publication
(10) Pub. No.: US 2026/0177830 A1
(43) Pub. Date: Jun. 25, 2026

(54) OPTICAL APPARATUS AND SYSTEM

(71) Applicant: HYPERVISION LTD, Yokneam Illit (IL)

(72) Inventors: Arthur Rabner, Yokneam Illit (IL); Shimon Grabarnik, Yokneam Illit (IL)

(73) Assignee: HYPERVISION LTD, Yokneam Illit (IL)

(21) Appl. No.: 19/405,611

(22) Filed: Dec. 2, 2025

Related U.S. Application Data
(60) Provisional application No. 63/738,331, filed on Dec. 23, 2024.

(51) Int. Cl. G02B 27/01; G02B 27/14; G02B 27/28

(52) U.S. Cl. CPC G02B 27/0172; G02B 27/141; G02B 27/283; G02B 2027/0123; G02B 2027/013

(57) ABSTRACT

For example, an apparatus may include an optical system, which may be configured to direct light from a display to an eye of a user according to a catoptric optical mechanism. For example, the catoptric optical mechanism may include a first folding surface, and a second folding surface. For example, at least one of the first folding surface or the second folding surface may include an aspherical surface. For example, the first folding surface and the second folding surface may be configured such that, for example, over at least 20 percent of a Field of View (FoV) of the optical system, a Back Focal Length (BFL) monotonically decreases with an increase in a viewing angle of the eye. For example, the BFL corresponding to a particular viewing angle may include a distance between the second folding surface and a field curvature surface corresponding to the particular viewing angle.

### CROSS REFERENCE

This application claims the benefit of and priority from U.S. Provisional Patent Application No. 63/738,331 entitled “OPTICAL APPARATUS AND SYSTEM”, filed Dec. 23, 2024, the entire disclosure of which is incorporated herein by reference.

### BACKGROUND

A Near Eye Display (NED) device and/or by a Head Mounted Display (HMD) device may be mounted on a head of a user, e.g., in front of the eye/eyes of the user.

The HMD and/or the NED may be used to display an image to the eyes of the user.

The HMD and/or the NED may be used, for example, for virtual reality games, augmented reality, simulators, metaverse applications, night vision devices, image intensifiers, and/or the like.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic illustration of a system, in accordance with some demonstrative aspects.

FIG. 2A is a schematic illustration of a graph depicting a Pixels Per Degree (PPD) value versus a viewing angle, in accordance with some demonstrative aspects.

FIG. 2B is a schematic illustration of a graph depicting a focal length versus a viewing angle, in accordance with some demonstrative aspects.

FIGS. 3A, 3B, 3C, and 3D are schematic illustrations of an optical system, in accordance with some demonstrative aspects.

FIG. 4A is a schematic illustration of a first graph depicting a total focal length of an optical system based on a first parameter, FIG. 4B is a schematic illustration of a second graph depicting the total focal length of the optical system based on a second parameter, and FIG. 4C is a schematic illustration of a third graph depicting a Back Focal Length (BFL) of the optical system, in accordance with some demonstrative aspects.

FIG. 5 is a schematic illustration of an optical system, in accordance with some demonstrative aspects.

FIG. 6 is a schematic illustration of optical system, in accordance with some demonstrative aspects.

FIG. 7 is a schematic illustration of an optical system, in accordance with some demonstrative aspects.

FIG. 8 is a schematic illustration of an optical system, in accordance with some demonstrative aspects.

FIG. 9 is a schematic illustration of an optical system, in accordance with some demonstrative aspects.

FIG. 10A is a schematic illustration of an optical system, in accordance with some demonstrative aspects.

FIG. 10B is a schematic illustration of a catoptric optical mechanism of the optical system of FIG. 10A, in accordance with some demonstrative aspects.

FIG. 10C is a schematic illustration of a construction scheme to demonstrate a construction of a first folding surface and a second folding surface corresponding to the optical system of FIG. 10A, in accordance with some demonstrative aspects.

FIG. 11A is a schematic illustration of an optical system, in accordance with some demonstrative aspects.

FIG. 11B is a schematic illustration of a catoptric optical mechanism of the optical system of FIG. 11A, in accordance with some demonstrative aspects.

FIG. 12A is a schematic illustration of an optical system, in accordance with some demonstrative aspects.

FIG. 12B is a schematic illustration of a catoptric optical mechanism of the optical system of FIG. 12A, in accordance with some demonstrative aspects.

FIG. 13A is a schematic illustration of an optical system, in accordance with some demonstrative aspects.

FIG. 13B is a schematic illustration of first curvatures, which may be implemented by lens surfaces of lenses of the optical system of FIG. 13A, in accordance with some demonstrative aspects.

FIG. 13C is a schematic illustration of second curvatures which may be implemented by lens surfaces of the lenses of the optical system of FIG. 13A, in accordance with some demonstrative aspects.

FIG. 14 is a schematic illustration of a system including an optical system to demonstrate a technical issue, which may be addressed, in accordance with some demonstrative aspects.

FIG. 15 is a schematic illustration of a system including an optical system, in accordance with some demonstrative aspects.

FIG. 16 is a schematic illustration of a system including an optical system, in accordance with some demonstrative aspects.

FIGS. 17A, 17B, and 17C are schematic illustrations of a distortion compensation scheme to demonstrate a distortion compensation of an optical system, in accordance with some demonstrative aspects.

FIG. 18 is a schematic illustration of a system including an optical system, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units, and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein include, for example, “multiple” or “two or more”. For example, “a plurality of items” includes two or more items.

The words “exemplary” and “demonstrative” are used herein to mean “serving as an example, instance, demonstration, or illustration”. Any aspect, or design described herein as “exemplary” or “demonstrative” is not necessarily to be construed as preferred or advantageous over other aspects, or designs.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

Some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be understood, however, that all of these and similar terms are to be associated with the appropriate physical quantities and are merely convenient labels applied to these quantities.

As used herein, the term “circuitry” may refer to, be part of, or include, an Application Specific Integrated Circuit (ASIC), an integrated circuit, an electronic circuit, a processor (shared, dedicated or group), and/or memory (shared, dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

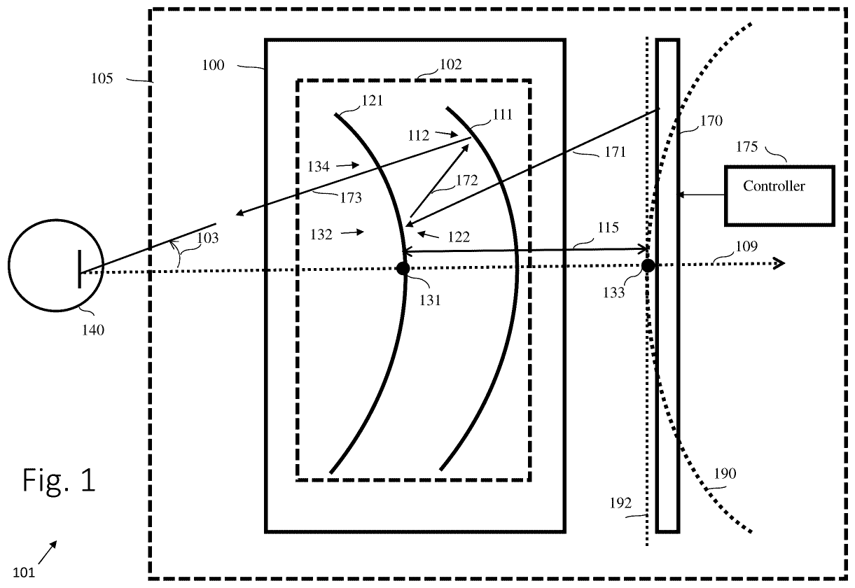

Reference is now made to FIG. 1, which schematically illustrates a system 101, in accordance with some demonstrative aspects.

In some demonstrative aspects, system 101 may include an electronic device 105, e.g., as described below.

In some demonstrative aspects, electronic device 105 may be configured to display an image to an eye 140 of a user, e.g., as described below.

In some demonstrative aspects, electronic device 105 may include or may be implemented, for example, by a Near Eye Display (NED) device, and/or by a Head Mounted Display (HMD) device, which may be mounted on a head of a user, e.g., in front of the eye/eyes of the user. In other aspects, electronic device 105 may include or may be implemented as part of any other type of device.

In some demonstrative aspects, electronic device 105 may be configured, for example, for night vision, and/or image intensifying applications, and the like.

In one example, electronic device 105 may be configured to be mounted and/or positioned in front of the eyes of a user. For example, electronic device 105 may be configured to be worn on a head of a user, or on a helmet, which may be worn on the head of the user.

In some demonstrative aspects, electronic device 105 may be configured to display an image to the user, e.g., a still image or a video image, to the user.

In some demonstrative aspects, electronic device 105 may be implemented, for example, for displaying images of an Extended Reality (XR) application, a Virtual Reality (VR) application, an augmented reality application, a gaming application, an aviation application, a simulator, an engineering application, a medical application, and/or to display images of any other additional or alternative applications and/or implementations.

In some demonstrative aspects, electronic device 105 may be implemented, for example, for displaying intensifying images of an environment. For example, system 101 may be implemented, for example, to display images of a dark environment.

In other aspects, electronic device 105 may be implemented, for example, for displaying images of an Extended Reality (XR) application, a Virtual Reality (VR) application, an augmented reality application, a gaming application, an aviation application, a simulator, an engineering application, a medical application, and/or to display images of any other additional or alternative applications and/or implementations.

In some demonstrative aspects, electronic device 105 may include a display 170, for example, to display an image, e.g., a still image or a video image, e.g., as described below.

In some demonstrative aspects, electronic device 105 may include an optical system 100, which may be configured to direct light 171 from display 170 to the eye 140 of the user, e.g., as described below.

In some demonstrative aspects, optical system 100 may be configured to direct light from display 170 to a pupil of eye 140, e.g., as described below.

In some demonstrative aspects, electronic device 105 may include a controller 175, which may be configured to control display 170, for example, to display the image, e.g., the still image or the video image, which may be viewed by the eye 140 of the user via optical system 100.

In one example, at least part of the functionality of controller 175 may be implemented by an integrated circuit, for example, a chip, e.g., a System on Chip (SoC).

In some demonstrative aspects, controller 175 may include, or may be implemented, partially or entirely, by circuitry and/or logic, e.g., one or more processors including circuitry and/or logic, and/or memory circuitry and/or logic. Additionally or alternatively, one or more functionalities of controller 175 may be implemented by logic, which may be executed by a machine and/or one or more processors, e.g., as described below.

In other aspects, controller 175 may be implemented by any other logic and/or circuitry, and/or according to any other architecture.

In one example, controller 175 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 175 may be based on any computer architecture, which may support rendering graphical information to be displayed by display 170.

In some demonstrative aspects, the optical system 100 may include a catoptric system, e.g., as described below.

In some demonstrative aspects, optical system 100 may include a catadioptric system, e.g., as described below.

In some demonstrative aspects, the catadioptric system may include one or more lens, e.g., as described below.

In some demonstrative aspects, optical system 100 may include any other additional and/or alternative type of optical system, e.g., as described below.

In some demonstrative aspects, optical system 100 may be configured to cover a wide Field of View (FoV)(wFoV), e.g., as described below.

In some demonstrative aspects, optical system 100 may be configured to cover the wFoV and/or to be in a compact form factor, e.g., as described below.

In some demonstrative aspects, optical system 100 may be configured to cover a wide FoV, for example, to improve a sense of immersion, presence, and/or performance for the user, for example, in tasks requiring peripheral vision, for example, in virtual environments and/or in augmented video-pass-through environments, e.g., as described below.

For example, a peripheral FoV and/or a peripheral vision may include a vision perception, which may occur outside a center of gaze or outside a straight-gaze of the eye of the user. For example, the peripheral FOV may include a FoV of a peripheral vision or indirect vision, which may occur outside a point of visual fixation, e.g., away from a center of gaze or, when viewed at large angles, in (or out of) the corner of the eye.

In some demonstrative aspects, optical system 100 may be configured to cover a horizontal FoV of at least 140 degrees (°), e.g., as described below.

In one example, optical system 100 may be configured to cover a horizontal FoV of about 170°, or even more.

In other aspects, optical system 100 may be configured to cover any other horizontal FoV.

In some demonstrative aspects, optical system 100 may be configured to cover a vertical FoV of about 160°, e.g., as described below.

In other aspects, optical system 100 may be configured to cover any other vertical FoV.

In some demonstrative aspects, optical system 100 may be configured to cover the wide FoV, for example, even without compromising a compactness, design and/or usability of optical system 100, e.g., as described below.

In some demonstrative aspects, optical system 100 may be configured to provide a technical solution to support a sharp big Eye-Box, and/or full vertical FOV vision, for example, for NED and/or HMD devices, e.g., as described below. For example, an Eye-Box of an optical system may include a 3D volume, which may be defined relative to the optical system. For example, the Eye-Box may include substantially all possible positions of the eye pupil relative to the optical system, for which an image quality provided by the optical system is in accordance with one or more criteria for the optical system, e.g., according to a specification of the optical system.

In some demonstrative aspects, optical system 100 may be configured to provide a technical solution to support an improved and/or increased sharpness acuity and/or contrast acuity, for example, to support the increased vision acuity, e.g., as described below.

In some demonstrative aspects, optical system 100 may be configured, such that, over at least 20 percent of the FoV of the optical system 100, a number of Pixels Per Degree (PPD) of the optical system 100 may monotonically decrease with an increase in a viewing angle 103 of the eye 140, e.g., as described below.

In some demonstrative aspects, the viewing angle 103 may be measured with respect to an optical axis 109 of the optical system 100, e.g., such that the viewing angle 103 may have positive values above an optical axis 109 of the optical system 100, and the viewing angle 103 may have negative values below the optical axis 109 of the optical system 100. Accordingly, the increase in the viewing angle 103, as described below, may be interpreted to relate to an increase in an absolute value of the viewing angle.

In some demonstrative aspects, the PPD may be defined for a viewing angle θ, e.g., as follows:

$$P P D ( θ ) = \frac{N}{δ θ}$$

wherein PPD(θ) denotes a value of PPD for the viewing angle θ, δθ denotes an angular interval, and N denotes the number of pixels in the angular interval δθ.

In some demonstrative aspects, optical system 100 may be configured such that, for example, over at least 20 percent of the FoV of the optical system 100, the value of PPD(θ) may be a decreasing function of the viewing angle θ For example, this configuration of the optical system 100 may provide a technical advantage, for example, for Virtual Reality (VR) optical systems, e.g., as described below.

In some demonstrative aspects, optical system 100 may be configured such that, for example, the value of PPD(θ) may be approximately constant from a viewing angle θ to a certain viewing angle θ1, and may start to decrease at viewing angles larger than θ1. For example, the configuration of the optical system 100 may provide a technical advantage, for example, for VR optical systems.

In some demonstrative aspects, optical system 100 may be configured, for example, such that, e.g., over at least 20 percent of the FoV of the optical system 100, the value of PPD(θ) may monotonically decrease with the increase in the viewing angle 103 of the eye 140, for example, to provide a technical solution to support an increased, e.g., a highest, resolution of a projected image in an image center of a displayed image, which may correspond, for example, to an increased, e.g., a highest, resolution of a human vision in a central gaze.

In some demonstrative aspects, optical system 100 may be configured, for example, such that, e.g., over at least 20 percent of the FoV of the optical system 100, the value of PPD(θ) may monotonically decrease with an increase in a viewing angle 103 of the eye 140, for example, to provide a technical solution to support an efficient way to use pixels of the display 170.

For example, optical system 100 may be configured such that a higher pixel density may be provided, e.g., at an image center of a displayed image, and/or a lower pixel density may be provided, e.g., at an image periphery of the displayed image.

In some demonstrative aspects, optical system 100 may be configured, for example, such that, e.g., over at least 20 percent of the FoV of the optical system 100, the value of PPD(θ) may monotonically decrease with the increase in the viewing angle 103 of the eye 140, for example, to provide a technical solution to support a higher FoV for a same display size, for example, as compared to a FoV supported by fixed-PPD lens, which may have a substantially constant value of PPD(θ) in the image center and in the image periphery of a displayed image.

In some demonstrative aspects, there may be one or more technical issues with an implementation of an “ideal” lens, for example, in an optical system to provide a value of the PPD(θ), which decreases with the increase in the viewing angle.

For example, a distortion, denoted Y, of an ideal lens may be determined according to a distortion law, e.g., as follows:

$$Y = F * tan ( θ ) \qquad ( 1 )$$

wherein F denotes a focal length of the ideal lens.

For example, a derivative of the distortion Y with respect to the viewing angle θ may be determined, e.g., as follows:

$$\frac{\partial Y}{\partial θ} = \frac{F}{cos {( θ )}^{2}} \qquad ( 2 )$$

For example, a PPD of an ideal lens, denoted PPD_{Ideal}(θ), may be determined, for example, based on division of Equation 2 by a display pixel pitch, denoted P, of a display, e.g., as follows:

$$P P {D}_{Ideal} ( θ ) = \frac{\frac{F}{p}}{cos {( θ )}^{2}} \qquad ( 3 )$$

For example, according to Equation (3), the PPD of the ideal lens may increase with the increase in the viewing angle θ.

For example, the focal length of the ideal lens may be constant with the increase in the viewing angle θ.

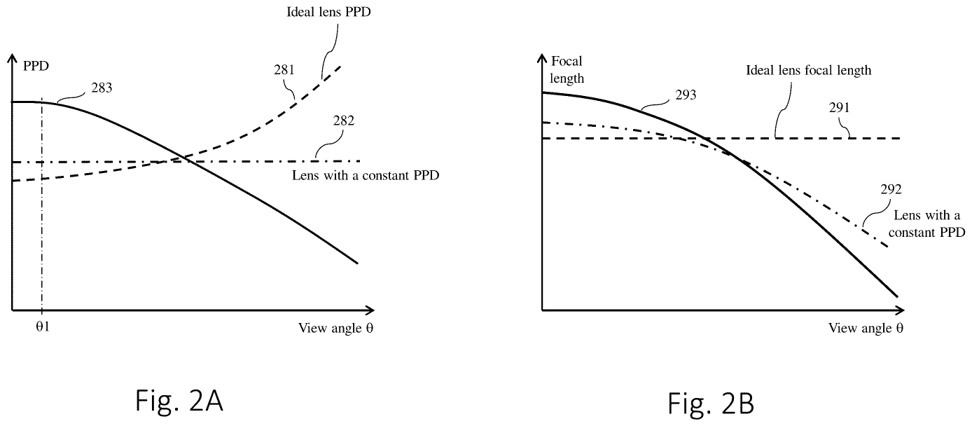

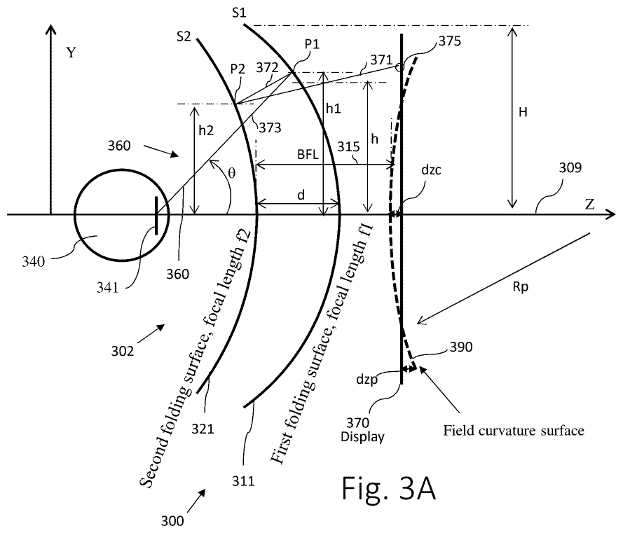

Reference is made to FIG. 2A, which schematically illustrates a first graph depicting a PPD value versus a viewing angle, and to FIG. 2B, which schematically illustrates a second graph depicting a focal length versus the viewing angle, in accordance with some demonstrative aspects.

For example, as shown in FIG. 2A, a curve 281 depicts a PPD of an ideal lens versus the viewing angle.

For example, as shown in FIG. 2A, the PPD according to curve 281 may increase with an increase in the viewing angle.

For example, as shown in FIG. 2B, a curve 291 depicts a focal length of the ideal lens versus the viewing angle.

For example, as shown in FIG. 2B, the focal lens according to curve 291 may remain constant with an increase in the viewing angle.

For example, as shown in FIG. 2A, a curve 282 depicts a PPD of a fixed-PPD lens versus the viewing angle.

For example, as shown in FIG. 2A, the PPD according to curve 282 may remain constant with an increase in the viewing angle.

For example, as shown in FIG. 2B, a curve 292 depicts a focal length of the fixed-PPD lens versus the viewing angle.

For example, as shown in FIG. 2B, the focal length according to curve 292 may decrease with an increase in the viewing angle.

For example, the constant PPD according to curve 282 may be achieved by a lens, for which the focal length decreases with the viewing angle.

In some demonstrative aspects, as shown in FIG. 2A, a curve 283 depicts a PPD of an optical system in accordance with some demonstrative aspects, e.g., optical system 100 (FIG. 1), versus the viewing angle of the optical system.

In some demonstrative aspects, as shown in FIG. 2A, the PPD according to curve 283 may decrease with an increase in the viewing angle.

In some demonstrative aspects, optical system 100 (FIG. 1) may be configured, for example, such that, e.g., over at least 20 percent of the FoV of the optical system 100 (FIG. 1), the PPD value of the optical system 100 may be configured according to the curve 283, for example, to provide a technical solution to support an efficient use of display pixels. For example, the PPD value of the optical system 100 (FIG. 1) may be configured according to the curve 283, e.g., as a decreasing function of the viewing angle, for example, starting from a predefined viewing angle θ1.

In some demonstrative aspects, optical system 100 (FIG. 1) may be configured, for example, such that, e.g., over at least 20 percent of the FoV of the optical system 100 (FIG. 1), the PPD value of the optical system 100 may be configured according to the curve 283, for example, to provide a technical solution to support an increased, e.g., a highest, PPD for low viewing angles, and/or to support a reduced, e.g., a lower, PPD for higher viewing angles. For example, this configuration of the PPD values may be based on the fact that a resolution of a human eye is typically highest close to a center of the human FoV, and decreases towards edges of the human FOV.

In some demonstrative aspects, as shown in FIG. 2B, a curve 293 depicts a total focal length of the optical system in accordance with some demonstrative aspects, e.g., optical system 100 (FIG. 1), versus the viewing angle.

In some demonstrative aspects, as shown in FIG. 2B, the focal length according to curve 293 may decrease with an increase in the viewing angle.

In some demonstrative aspects, optical system 100 (FIG. 1) may be configured, for example, such that, e.g., over at least 20 percent of the FoV of the optical system 100 (FIG. 1), the total focal length of optical system 100 (FIG. 1) may be configured according to the curve 293.

Referring back to FIG. 1, in some demonstrative aspects, optical system 100 may be configured to direct the light 171 from the display 170 to the eye 140, for example, according to a catoptric optical mechanism 102, e.g., as described below.

In some demonstrative aspects, catoptric optical mechanism 102 may include a first folding surface 111, e.g., as described below.

In some demonstrative aspects, catoptric optical mechanism 102 may include a second folding surface 121, e.g., as described below.

In some demonstrative aspects, the first folding surface 111 and/or the second folding surface 121 may include an aspherical surface, e.g., as described below.

In some demonstrative aspects, the first folding surface 111 may include the aspherical surface, and the second folding surface 121 may include a spherical surface, e.g., as described below.

In some demonstrative aspects, the second folding surface 121 may include the aspherical surface, and the first folding surface 111 may include a spherical surface, e.g., as described below.

In some demonstrative aspects, the first folding surface 111 may include a first aspherical surface, and the second folding surface 121 may include a second aspherical surface, e.g., as described below.

In some demonstrative aspects, the first folding surface 111 may be configured to transfer the light 171 from the display 170 towards the second folding surface 121, e.g., as described below.

In some demonstrative aspects, the first folding surface 111 may be configured to reflect light 172, which has been reflected from the second folding surface 121, towards the eye 140, e.g., as described below.

In some demonstrative aspects, the second folding surface 121 may be configured to reflect the light 171 from the display 170 towards the first folding surface 111, e.g., as described below.

In some demonstrative aspects, the second folding surface 121 may be configured to transfer reflected light 173 from the first folding surface 111 towards the eye 140, e.g., as described below.

In some demonstrative aspects, the first folding surface 111 and the second folding surface 121 may be configured such that, over at least 20 percent of a Field of View (FoV) of the optical system 100, a Back Focal Length (BFL) 115 may monotonically decrease, for example, with an increase in the viewing angle 103 of the eye 140, e.g., as described below.

In some demonstrative aspects, the BFL 115 corresponding to a particular viewing angle 103 may include a distance between the second folding surface 121 and a field curvature surface 190 corresponding to the particular viewing angle 103, e.g., as described below.

In some demonstrative aspects, the field curvature surface 190 corresponding to the particular viewing angle 103 may be based, for example, on a first curvature 112 of the first folding surface 111 at the particular viewing angle 103, and a second curvature 122 of the second folding surface 121 corresponding to the particular viewing angle 103, e.g., as described below.

In some demonstrative aspects, the first folding surface 111 and the second folding surface 121 may be configured, for example, such that, over at least 30 percent of the FoV of the optical system 100, the BFL 115 may monotonically decrease with the increase in the viewing angle 103 of the eye 140, e.g., as described below.

In some demonstrative aspects, the first folding surface 111 and the second folding surface 121 may be configured, for example, such that, over at least 50 percent of the FoV of the optical system 100, the BFL 115 may monotonically decrease with the increase in the viewing angle 103 of the eye 140, e.g., as described below.

In some demonstrative aspects, the first folding surface 111 and the second folding surface 121 may be configured, for example, such that, over at least 55 percent of the FoV of the optical system 100, the BFL 115 may monotonically decrease with the increase in the viewing angle 103 of the eye 140, e.g., as described below.

In some demonstrative aspects, the first folding surface 111 and the second folding surface 121 may be configured, for example, such that, over at least 70 percent of the FoV of the optical system 100, the BFL 115 may monotonically decrease with the increase in the viewing angle 103 of the eye 140, e.g., as described below.

In some demonstrative aspects, the first folding surface 111 and the second folding surface 121 may be configured, for example, such that, over at least 80 percent of the FoV of the optical system 100, the BFL 115 may monotonically decrease with the increase in the viewing angle 103 of the eye 140, e.g., as described below.

In some demonstrative aspects, the first folding surface 111 and the second folding surface 121 may be configured, for example, such that, over at least 90 percent of the FoV of the optical system 100, the BFL 115 may monotonically decrease with the increase in the viewing angle 103 of the eye 140, e.g., as described below.

In some demonstrative aspects, the first folding surface 111 and the second folding surface 121 may be configured, for example, such that, over at least 99 percent of the FoV of the optical system 100, the BFL 115 may monotonically decrease with the increase in the viewing angle 103 of the eye 140, e.g., as described below.

In other aspects, the first folding surface 111 and the second folding surface 121 may be configured, such that, the BFL 115 may monotonically decrease with the increase in the viewing angle 103 of the eye 140, for example, with respect to any other suitable portion of the FoV of the optical system 100, e.g., with respect to any other suitable portion of the aperture radius of the optical system 100.

In some demonstrative aspects, the criterion “over at least XX % of the of the FoV of the optical system 100”, when used with respect to the BFL 115 monotonically decreasing with the increase in the viewing angle 103 of the eye 140, may include a criterion relating to one or more portions of the FoV, which form at least XX % of the FoV of the optical system 100 in a direction perpendicular to an optical axis 109 of the optical system 100.

In one example, the one or more portions may include a single continuous portion of the FoV, which forms at least XX % of the FoV. According to this example, the first folding surface 111 and the second folding surface 121 may be configured such that, over a single continuous portion along at least XX % of the FoV, the BFL 115 may monotonically decrease with the increase in the viewing angle 103 of the eye 140.

In another example, the one or more portions may include a plurality of non-continuous portions along the FoV, which together form at least XX % of the FoV of the optical system 100. According to this example, the BFL 115 may monotonically decrease with the increase in the viewing angle 103 of the eye 140 in each of the one or more portions. For example, the one or more portions may include Q>1 portions, including a first portion along XX1% of the FoV, and an Q-th portion along XXQ % of the FoV, for example, such that sum (XX1%, . . . ,XXQ %) is at least XX % of the FoV.

In one example, the first folding surface 111 and the second folding surface 121 may be configured, such that, there may be a first portion along 5% of the FoV, in which the BFL 115 may monotonically decrease with the increase in the viewing angle 103 of the eye 140; a second portion along 10% of the FoV, in which the BFL 115 may monotonically decrease with the increase in the viewing angle 103 of the eye 140; a third portion along 8% of the FoV, in which the BFL 115 may monotonically decrease with the increase in the viewing angle 103 of the eye 140; and a fourth portion along 9% of the FoV, in which the BFL 115 may monotonically decrease with the increase in the viewing angle 103 of the eye 140. According to this example, it may be said that the first folding surface 111 and the second folding surface 121 may be configured such that, over 5+10+8+9=32% of the FoV, the BFL 115 may monotonically decrease with the increase in the viewing angle 103 of the eye 140.

In some demonstrative aspects, the first folding surface 111 and the second folding surface 121 may be configured such that, for example, over at least 20 percent of the FoV of the optical system 100, a number of PPD of the optical system 100 may monotonically decrease with the increase in the viewing angle 103 of the eye 140, e.g., as described below.

In some demonstrative aspects, the first folding surface 111 and the second folding surface 121 may be configured such that, for example, over at least 25 percent of the FoV of the optical system 100, the number of PPD of the optical system 100 may monotonically decrease with the increase in the viewing angle 103 of the eye 140, e.g., as described below.

In some demonstrative aspects, the first folding surface 111 and the second folding surface 121 may be configured such that, for example, over at least 30 percent of the FoV of the optical system 100, the number of PPD of the optical system 100 may monotonically decrease with the increase in the viewing angle 103 of the eye 140, e.g., as described below.

In some demonstrative aspects, the first folding surface 111 and the second folding surface 121 may be configured such that, for example, over at least 50 percent of the FoV of the optical system 100, the number of PPD of the optical system 100 may monotonically decrease with the increase in the viewing angle 103 of the eye 140, e.g., as described below.

In some demonstrative aspects, the first folding surface 111 and the second folding surface 121 may be configured such that, for example, over at least 55 percent of the FoV of the optical system 100, the number of PPD of the optical system 100 may monotonically decrease with the increase in the viewing angle 103 of the eye 140, e.g., as described below.

In other aspects, the first folding surface 111 and the second folding surface 121 may be configured, such that, for example, the number of PPD may monotonically decrease with the increase in the viewing angle 103 of the eye 140 with respect to any other suitable portion of the FoV of the optical system 100, e.g., with respect to any other suitable portion of the aperture radius of the optical system 100.

In some demonstrative aspects, the first folding surface 111 and the second folding surface 121 may be configured such that, for example, over at least 20 percent of the FoV of the optical system 100, a total focal length of the optical system 100 may monotonically decrease with the increase in the viewing angle 103 of the eye 140, e.g., as described below.

In some demonstrative aspects, the first folding surface 111 and the second folding surface 121 may be configured such that, for example, over at least 30 percent of the FoV of the optical system 100, the total focal length of the optical system 100 may monotonically decrease with the increase in the viewing angle 103 of the eye 140, e.g., as described below.

In some demonstrative aspects, the first folding surface 111 and the second folding surface 121 may be configured such that, for example, over at least 50 percent of the FoV of the optical system 100, the total focal length of the optical system 100 may monotonically decrease with the increase in the viewing angle 103 of the eye 140, e.g., as described below.

In some demonstrative aspects, the first folding surface 111 and the second folding surface 121 may be configured such that, for example, over at least 55 percent of the FoV of the optical system 100, the total focal length of the optical system 100 may monotonically decrease with the increase in the viewing angle 103 of the eye 140, e.g., as described below.

In other aspects, the first folding surface 111 and the second folding surface 121 may be configured, such that, for example, the total focal length may monotonically decrease with the increase in the viewing angle 103 of the eye 140 with respect to any other suitable portion of the FoV of the optical system 100, e.g., with respect to any other suitable portion of the aperture radius of the optical system 100.

In some demonstrative aspects, a value of the total focal length corresponding to the particular viewing angle 103 may be based, for example, on a first focal length and a second focal length, e.g., as described below.

In some demonstrative aspects, the first focal length may be based, for example, on the first curvature 112, e.g., as described below.

In some demonstrative aspects, the second focal length may be based, for example, on the second curvature 122, e.g., as described below.

In some demonstrative aspects, the first folding surface 111 may be configured such that a focal length of the first folding surface 111 may be positive for any viewing angle 103, for example, in at least 20 percent of the FoV of the optical system 100, e.g., as described below.

In other aspects, the first folding surface 111 may be configured such that the focal length of the first folding surface 111 may be positive for any viewing angle 103, for example, with respect to any other suitable portion of the FoV of the optical system 100, e.g., with respect to any other suitable portion of the aperture radius of the optical system 100.

In some demonstrative aspects, the second folding surface 121 may be configured such that a focal length of the second folding surface 121 may be negative for any viewing angle 103, for example, in at least 20 percent of the FoV of the optical system 100, e.g., as described below.

In other aspects, the second folding surface 121 may be configured such that the focal length of the second folding surface 121 may be negative for any viewing angle 103, for example, with respect to any other suitable portion of the FoV of the optical system 100, e.g., with respect to any other suitable portion of the aperture radius of the optical system 100.

In one example, a curvature of a folding surface, e.g., the first folding surface 111 and/or the second folding surface 121, which reflects and/or folds a light beam, may be defined to include a positive value, for example, if the folding surface is concave towards the light beam.

In another example, the curvature of the folding surface may be defined to include a negative value, for example, if the folding surface is convex towards the light beam.

In some demonstrative aspects, the first folding surface 111 and the second folding surface 121 may be configured such that, for any particular viewing angle 103, for example, in at least 20 percent of the FoV of the optical system 100, an absolute value of the first focal length may be less than an absolute value of the second focal length, e.g., as described below.

In other aspects, the first folding surface 111 and the second folding surface 121 may be configured such that the absolute value of the first focal length may be less than the absolute value of the second focal length, for example, with respect to any other suitable portion of the FoV of the optical system 100, e.g., with respect to any other suitable portion of the aperture radius of the optical system 100.

In some demonstrative aspects, the field curvature surface 190 corresponding to the particular viewing angle 103 may be convex towards the eye 140, e.g., as described below.

In some demonstrative aspects, the field curvature surface 190 corresponding to the particular viewing angle 103 may be convex towards the eye 140, for example, for any viewing angle 103, for example, in at least 20 percent of the FoV of the optical system 100, e.g., as described below.

In some demonstrative aspects, the field curvature surface 190 corresponding to the particular viewing angle 103 may be centered at the optical axis 109 of the optical system 100, e.g., as described below.

In some demonstrative aspects, the field curvature surface 190 corresponding to the particular viewing angle 103 may include a Petzval surface, e.g., as described below.

In other aspects, the field curvature surface 190 corresponding to the particular viewing angle 103 may include any other type of surface.

In some demonstrative aspects, the field curvature surface 190 corresponding to the particular viewing angle 103 may include a virtual field curvature surface, which may be formed, for example, by a first virtual optical surface having the first curvature 112, and a second virtual optical surface having the second curvature 122, e.g., as described below.

In some demonstrative aspects, the first folding surface 111 and the second folding surface 121 may be configured, for example, such that a curvature of a system field curvature surface 192 corresponding to the optical system 100 may be based, for example, on a curvature of a display surface of the display 170, e.g., as described below.

In some demonstrative aspects, the system field curvature surface 192 may be formed by a plurality of points on a plurality of field curvature surfaces 190, e.g., as described below.

In some demonstrative aspects, the plurality of field curvature surfaces 190 may correspond to a plurality of viewing angles 103, e.g., as described below.

In some demonstrative aspects, a point of the plurality of points on the plurality of field curvature surfaces 190 may include an intersection between the particular viewing angle 103 and the field curvature surface 190 corresponding to the particular viewing angle 103, e.g., as described below.

In one example, as shown in FIG. 1, optical system 100 may be configured, for example, such that the system field curvature surface 192 may be substantially planar, for example, to coincide with a planar display surface of the display 170.

In another example, optical system 100 may be configured, for example, such that the system field curvature surface 192 may be non-planar, e.g., convex or concave, for example, to coincide with a non-planar display surface of the display 170. In one example, display 170 may have a non-planar display surface, for example, when the display 170 includes an optical fiber taper screen, e.g., which may be implemented as part of an image intensifier of a night vision device.

In some demonstrative aspects, the first curvature 112 of the first folding surface 111 at the particular viewing angle 103 may include a curvature of the first folding surface 111 at a portion of the first folding surface 111 to reflect light from the second folding surface 112, e.g., the reflected light 173, towards the eye 140 at the particular viewing angle 103, e.g., as described below.

In some demonstrative aspects, the second curvature 122 of the second folding surface 121 corresponding to the particular viewing angle 101 may include a curvature of the second folding surface 121 at a portion of the second folding surface 121 to reflect towards the first folding surface 111 the light 171 from the display 170 to be provided to the eye 140, for example, at the particular viewing angle 103, e.g., as described below.

In some demonstrative aspects, the viewing angle 103 of the eye 140 may include an angle between the optical axis 109 of the optical system 100 and a line between a center of a pupil of the eye 140 and a point on the first folding surface 111, e.g., as described below.

In some demonstrative aspects, the first folding surface 111 and the second folding surface 121 may be configured, for example, such that a first BFL corresponding to a first viewing angle 103 may be longer than a second BFL corresponding to a second viewing angle 103, e.g., as described below.

In some demonstrative aspects, the second viewing angle 103 may be greater than the first viewing angle 103, e.g., as described below.

In some demonstrative aspects, the BFL 115 corresponding to the particular viewing angle 103 may be based, for example, on a distance between a first intersection point 131 and a second intersection point 133 along the optical axis 109 of the optical system 100, e.g., as described below.

In some demonstrative aspects, the first intersection point 131 may include an intersection between the optical axis 109 and the second folding surface 121, e.g., as described below.

In some demonstrative aspects, the second intersection 133 may include an intersection between the optical axis 109 and the field curvature surface 190 corresponding to the particular viewing angle 103, e.g., as described below.

In some demonstrative aspects, the first folding surface 111 and the second folding surface 121 may be configured such that, for example, over at least 20 percent of the FoV of the optical system 100, a curvature of the aspherical surface, e.g., the first folding surface 111 and/or the second folding surface 121, may monotonically increase with the increase in the viewing angle 103 of the eye 140, e.g., as described below.

In some demonstrative aspects, the first folding surface 111 and the second folding surface 121 may be configured such that, for example, over at least 20 percent of the FoV of the optical system 100, a curvature of the aspherical surface, e.g., the first folding surface 111 and/or the second folding surface 121, may monotonically decrease with the increase in the viewing angle 103 of the eye 140, e.g., as described below.

In some demonstrative aspects, the first folding surface 111 and the second folding surface 121 may be configured such that the aspherical surface, e.g., the first folding surface 111 and/or the second folding surface 121, may include an axis portion and an edge portion, e.g., as described below.

In some demonstrative aspects, the axis portion of the aspherical surface may be between the optical axis 109 of the optical system 100 and an inflection point on the aspherical surface, e.g., as described below.

In some demonstrative aspects, the edge portion of the aspherical surface may be between the inflection point and an edge of the optical system 100, e.g., as described below.

In some demonstrative aspects, the aspherical surface may be configured, for example, such that a curvature of one portion of the edge portion or the axis portion may be positive over at least 20 percent of the one portion, and a curvature of an other portion of the edge portion or the axis portion may be negative over at least 20 percent of the other portion, e.g., as described below.

In one example, the aspheric surface may have a positive curvature at one distance from the optical axis 109 and may have a negative curvature at another distance from the optical axis 109, or vice versa. According to this example, the inflection point of the aspheric surface may include the point at which the curvature of the aspheric surface changes its sign.

In some demonstrative aspects, the first folding surface 111 may include the aspherical surface, and the second folding surface 121 may include a spherical surface, for example, according to a first configuration of the catoptric optical mechanism 102, e.g., as described below.

In some demonstrative aspects, the first folding surface 111 may be configured such that, for example, over at least 20 percent of the FoV of the optical system 100, the curvature of the first folding surface 111 may monotonically increase with the increase in the viewing angle 103 of the eye 140, for example, according to the first configuration of the catoptric optical mechanism 102, e.g., as described below.

In some demonstrative aspects, the second folding surface 121 may include the aspherical surface, and the first folding surface 111 may include a spherical surface, for example, according to a second configuration of the catoptric optical mechanism 102, e.g., as described below.

In some demonstrative aspects, the second folding surface 121 may be configured such that, for example, over at least 20 percent of the FoV of the optical system 100, the curvature of the second folding surface 121 may be negative and may monotonically increase with the increase in the viewing angle 103 of the eye 140, for example, according to the second configuration of the catoptric optical mechanism 102, e.g., as described below.

In some demonstrative aspects, the second folding surface 121 may include an inflection point, for example, according to the second configuration of the catoptric optical mechanism 102, e.g., as described below.

In some demonstrative aspects, the second folding surface 121 may be configured such that, for example, over at least 20 percent of a first range of viewing angles 103 between the optical axis 109 of the optical system 100 and the inflection point on the second folding surface 121, the curvature of the second folding surface 121 may be negative and monotonically increasing with the increase in the viewing angle 103 of the eye 140, for example, according to the second configuration of the catoptric optical mechanism 102, e.g., as described below.

In some demonstrative aspects, the second folding surface 121 may be configured such that, for example, over at least 20 percent of a second range of viewing angles 103 between the inflection point on the second folding surface 121 and an edge of the optical system 100, the curvature of the second folding surface 121 may be positive and monotonically increasing with the increase in the viewing angle 103 of the eye 140, for example, according to the second configuration of the catoptric optical mechanism 102, e.g., as described below.

In some demonstrative aspects, the first folding surface 111 may include a first aspherical surface, and the second folding surface 121 may include a second aspherical surface, e.g., as described below.

In some demonstrative aspects, the first folding surface 111 may be configured such that, for example, over at least 20 percent of the FoV of the optical system 100, the curvature of the first folding surface 111 may monotonically increase with the increase in the viewing angle 103 of the eye 140, for example, according to a third configuration of the catoptric optical mechanism 102, e.g., as described below.

In some demonstrative aspects, the second folding surface 121 may be configured such that, for example, over at least 20 percent of the FoV of the optical system 100, the curvature of the second folding surface 121 may be negative and may monotonically increase with the increase in the viewing angle 103 of the eye 140, for example, according to the third configuration of the catoptric optical mechanism 102, e.g., as described below.

In some demonstrative aspects, the second folding surface 121 may include an inflection point, for example, according to the third configuration of the catoptric optical mechanism 102, e.g., as described below.

In some demonstrative aspects, the second folding surface 121 may be configured such that, for example, over at least 20 percent of a first range of viewing angles 103 between the optical axis 109 of the optical system 100 and the inflection point on the second folding surface 121, the curvature of the second folding surface 121 may be negative and monotonically increasing with the increase in the viewing angle 103 of the eye 140, for example, according to the third configuration of the catoptric optical mechanism 102, e.g., as described below.

In some demonstrative aspects, the second folding surface 121 may be configured such that, for example, over at least 20 percent of a second range of viewing angles 103 between the inflection point on the second folding surface 121 and an edge of the optical system 100, the curvature of the second folding surface 121 may be positive and monotonically increasing with the increase in the viewing angle 103 of the eye 140, for example, according to the third configuration of the catoptric optical mechanism 102, e.g., as described below.

In some demonstrative aspects, the first folding surface 111 may be configured such that, for example, over at least 20 percent of the FoV of the optical system 100, the curvature of the first folding surface 111 may be positive and may monotonically decrease with the increase in the viewing angle 103 of the eye 140, for example, according to a fourth configuration of the catoptric optical mechanism 102, e.g., as described below.

In some demonstrative aspects, the second folding surface 121 may be configured such that, for example, over at least 20 percent of the FoV of the optical system 100, the curvature of the second folding surface 121 may be negative and monotonically increasing with the increase in the viewing angle 103 of the eye 140, for example, according to the fourth configuration of the catoptric optical mechanism 102, e.g., as described below.

In some demonstrative aspects, an increase rate of the curvature of the second folding surface 121 may be greater than a decrease rate of the curvature of the first folding surface 111, for example, according to the fourth configuration of the catoptric optical mechanism 102, e.g., as described below.

In some demonstrative aspects, the first folding surface 111 may be configured such that, for example, over at least 20 percent of a first range of viewing angles 103 between the optical axis 109 of the optical system 100 and a first inflection point on the first folding surface 111, a curvature of the first folding surface 111 may be positive and may monotonically decrease with the increase in the viewing angle 103 of the eye 140, for example, according to a fifth configuration of the catoptric optical mechanism 102, e.g., as described below.

In some demonstrative aspects, the first folding surface 111 may be configured such that, for example, over at least 20 percent of a second range of viewing angles 103 between the first inflection point and an edge of the optical system 100, the curvature of the first folding surface 111 may be negative and may monotonically decrease with the increase in the viewing angle 103 of the eye 140, for example, according to the fifth configuration of the catoptric optical mechanism 102, e.g., as described below.

In some demonstrative aspects, the second folding surface 121 may be configured such that, for example, over at least 20 percent of a third range of viewing angles 103 between the optical axis 109 of the optical system 100 and a second inflection point on the second folding surface 121, the curvature of the second folding surface 121 may be negative and may monotonically increase with the increase in the viewing angle 103 of the eye 140, for example, according to the fifth configuration of the catoptric optical mechanism 102, e.g., as described below.

In some demonstrative aspects, the second folding surface 121 may be configured such that, for example, over at least 20 percent of a fourth range of viewing angles 103 between the second inflection point and the edge of the optical system 100, the curvature of the second folding surface 121 may be positive and may monotonically increase with the increase in the viewing angle 103 of the eye 140, for example, according to the fifth configuration of the catoptric optical mechanism 102, e.g., as described below.

In some demonstrative aspects, a rate of a change in the curvature of the first folding surface 111 may be greater than a rate of a change in the curvature of the second folding surface 121, for example, according to the fifth configuration of the catoptric optical mechanism 102, e.g., as described below.

In some demonstrative aspects, the optical system 100 may include a catoptric system, e.g., as described below.

In some demonstrative aspects, the catoptric system may include a semi-reflective mirror (not shown in FIG. 1) to provide the first folding surface 111, e.g., as described below.

In some demonstrative aspects, the catoptric system may include a reflective polarizer (not shown in FIG. 1) to provide the second folding surface 121, e.g., as described below.

In some demonstrative aspects, the reflective polarizer may include a circular reflective polarizer including a single optical element, e.g., as described below.

In some demonstrative aspects, the reflective polarizer may include a linear reflective polarizer, which may be combined with a quarter-wave optical retarder, e.g., as described below.

In other aspects, any other additional and/or alternative implementation of the reflective polarizer may be utilized.

In some demonstrative aspects, the optical system 100 may include a single lens (not shown in FIG. 1) according to a first single-lens configuration, e.g., as described below.

In some demonstrative aspects, the single lens may include a first optical surface, e.g., as described below.

In some demonstrative aspects, the single lens may include a second optical surface opposite to the first optical surface, e.g., as described below.

In some demonstrative aspects, the optical system 100 may include a single lens (not shown in FIG. 1) according to a second single-lens configuration, e.g., as described below.

In some demonstrative aspects, the single lens may include an optical surface, e.g., as described below.

In some demonstrative aspects, the single lens may include a refractive surface opposite to the optical surface, e.g., as described below.

In some demonstrative aspects, the single lens may include a folding layer between the optical surface and the refractive surface, e.g., as described below.

In some demonstrative aspects, the optical system 100 may include an eye-lens (not shown in FIG. 1) and a display lens (not shown in FIG. 1), e.g., as described below.

In other aspects, the optical system 100 may include any other additional and/or alternative optical elements, and/or may be configured according to any other optical structure and/or architecture.

In some demonstrative aspects, the FoV of the optical system 100 may include a central FoV portion 132 and a peripheral FoV portion 134, e.g., as described below.

In some demonstrative aspects, the central FoV portion 132 may correspond to a central gaze of the eye 140, e.g., as described below.

In some demonstrative aspects, the peripheral FoV portion 134 may correspond to a peripheral gaze of the eye 140, e.g., as described below.

In some demonstrative aspects, the optical system 100 may be configured, for example, such that a distortion of the optical system 100 at the peripheral FoV portion 134 may be greater than a distortion of the optical system 100 at the central FoV portion 132, e.g., as described below.

In some demonstrative aspects, the distortion of the optical system 100 at the central FoV portion 132 may be opposite to a distortion of an objective of the optical system at the central FoV portion 132, e.g., as described below.

In some demonstrative aspects, system 101 may include a fiber optic taper (not shown in FIG. 1) between the display 170 and the optical system 100, e.g., as described below.

In some demonstrative aspects, the fiber optic taper may include a first surface facing the display 170 and a second surface facing the optical system 100, e.g., as described below.

In some demonstrative aspects, an area of the second surface may be greater than an area of the first surface, e.g., as described below.

In some demonstrative aspects, system 101 may include an objective (not shown in FIG. 1) and a photomultiplier (not shown in FIG. 1), e.g., as described below.

In some demonstrative aspects, electronic device 105 may include a night vision device including the objective, the photomultiplier, the fiber optic taper, the display 170, and the optical system 100, e.g., as described below.

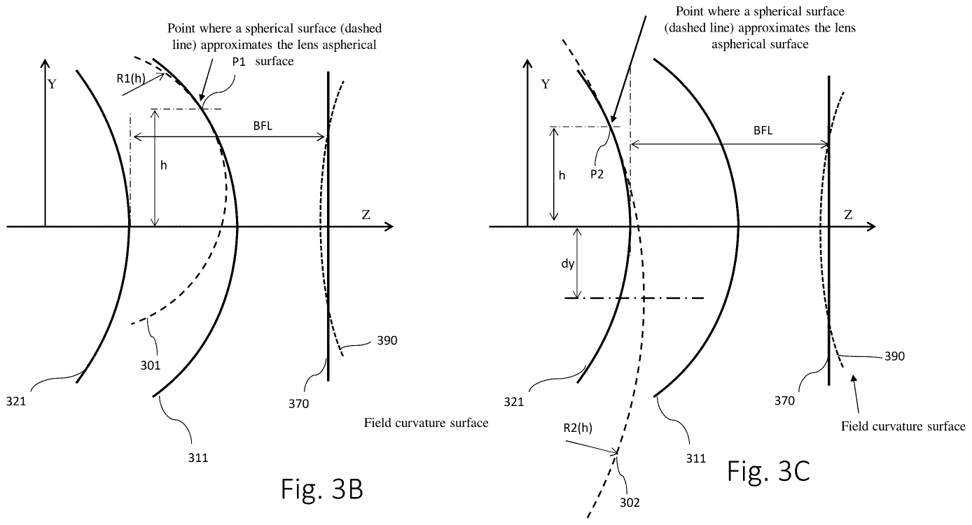

Reference is made to FIGS. 3A, 3B, 3C, and 3D, which schematically illustrates an optical system 300, in accordance with some demonstrative aspects.

For example, system 101 (FIG. 1) and/or optical system 100 (FIG. 1) may include one or more elements of optical system 300, and/or may be configured to provide at least part of the functionality of optical system 300.

In some demonstrative aspects, as shown in FIG. 3A, optical system 300 may be configured to direct light from a display 370 to an eye 340 of a user, for example, according to a catoptric optical mechanism 302. For example, catoptric optical mechanism 102 (FIG. 1) may include catoptric optical mechanism 302.

In some demonstrative aspects, as shown in FIG. 3A, catoptric optical mechanism 302 may include a first folding surface 311, denoted S1.

In some demonstrative aspects, as shown in FIG. 3A, catoptric optical mechanism 302 may include a second folding surface 321, denoted S2.

In one example, a medium between the folding surfaces 321 and 311 may include air or any other additional and/or alternative material or substance.

In some demonstrative aspects, as shown in FIG. 3A, the first folding surface 311 may be configured to transfer light 371 from the display 370 towards the second folding surface 321.

In some demonstrative aspects, as shown in FIG. 3A, the first folding surface 311 may be configured to reflect light 372 from the second folding surface 321 towards the eye 340.

In some demonstrative aspects, as shown in FIG. 3A, the second folding surface 321 may be configured to reflect the light 371 from the display 370 towards the first folding surface 311.

In some demonstrative aspects, as shown in FIG. 3A, the second folding surface 321 may be configured to transfer reflected light 373, which has been reflected from the first folding surface 311, towards the eye 340.

In some demonstrative aspects, the first folding surface 311 and the second folding surface 321 may be configured such that, for example, over at least 20 percent of a FoV of the optical system 300, a BFL 315 may monotonically decrease, for example, with an increase in a viewing angle θ of the eye 340.

In some demonstrative aspects, a BFL 315 corresponding to a particular viewing angle θ may include a distance between the second folding surface 321 and a field curvature surface 390 corresponding to the particular viewing angle θ.

In some demonstrative aspects, the field curvature surface 390 corresponding to the particular viewing angle θ may be based, for example, on a first curvature of the first folding surface 311 at the particular viewing angle 303, e.g., at a first point, denoted P1, and based, for example, on a second curvature of the second folding surface 321 at a second point, denoted P2, e.g., corresponding to the particular viewing angle θ.

In some demonstrative aspects, the first folding surface 311 and the second folding surface 321 may be configured such that, for example, over at least 20 percent of the FoV of the optical system 300, a PPD value of the optical system 300 may monotonically decrease with the increase in the viewing angle 303 of the eye 340.

In some demonstrative aspects, the first folding surface 311 and the second folding surface 321 may be configured such that, for example, over at least 20 percent of the FoV of the optical system 300, a total focal length of the optical system 300 may monotonically decrease with the increase in the viewing angle 303 of the eye 340.

In one example, optical system 300 may include a simplified optical system, e.g., a catoptric optical system, for example, including only the first folding surface 311 and the second folding surface 321.

In some demonstrative aspects, as shown in FIG. 3A, a light beam 360 may be emitted by a pixel 375 of the display 370.

In some demonstrative aspects, as shown in FIG. 3A, the light beam 360 may propagate towards a pupil 341 of the eye 340.

For example, light beam 360 may include the light 371 from the display 370, the light 372 from the second folding surface 321, and the reflected light 373 from the first folding surface 311 towards the eye 340.

In one example, the light beam 360 may be considered in back propagation, e.g., a backward raytracing.

According to this example, a back propagation of the light beam 360 may be emitted from the eye pupil 341 as a collimated beam at the angle θ with respect to an optical axis 309 of the optical system 300.

For example, the back propagation of light beam 360 may be reflected by the first folding surface 311 and the second folding surface 321, and may be focused on a surface of the display 370.

In one example, the back propagation of light beam 360 may not be collimated, for example, if an eye accommodation is not at infinity.

In one example, optical system 300 may be configured to provide a virtual image at a certain distance from the eye 340. According to this example, the back propagation of light beam 360 may converge, for example, when exiting the eye pupil 341, for example, in the backward raytracing.

In some demonstrative aspects, as shown in FIG. 3A, the back propagation of light beam 360 may be reflected from the first folding surface 311 at the first point P1, which may be at a first height, denoted h1, from the optical axis 309 of the optical system 300.

In some demonstrative aspects, as shown in FIG. 3A, the back propagation of light beam 360 may be reflected from the second folding surface 321 at the second point P2, which may be at a second height, denoted h2, from the optical axis 309 of the optical system 300.

In some demonstrative aspects, a third height, denoted h, may represent a height of the back propagation of light beam 360 with respect to the optical system 300. For example, the third height h may be between the first height h1 and the second height h2, e.g., h2<h<h1.

In some demonstrative aspects, the third height h may correspond to the particular viewing angle θ.

In one example, the optical surfaces 321 and 311 may be approximated by sphere surfaces, for example, which may be represented as a paraxial system of thin lenses, e.g., as described below.

In one example, a total focal length, denoted f, of the optical system 300 corresponding to the particular viewing angle θ may be determined, for example, assuming that the optical surfaces 321 and 311 are spherical, e.g., as follows:

$$\frac{1}{f} = \frac{1}{f 1} + \frac{1}{f 2} - \frac{d}{f 1 f 2} \qquad ( 4 )$$

wherein f1 denotes a focal length of the first folding surface 311, f2 denotes a focal length of the second folding surface 321, and d denotes a distance between the first folding surface 311 and the second folding surface 321 for example, assuming that the optical surfaces 321 and 311 are spherical.

In one example, a BFL, denoted BFL, of the optical system 300 corresponding to the particular viewing angle θ may be determined, for example, assuming that the optical surfaces 321 and 311 are spherical, e.g., as follows:

$$B F L = \frac{f 2 ( d - f 1 )}{d - ( f 1 + f 2 )} \qquad ( 5 )$$

In one example, the total focal length f may be determined by rewriting Equation 4, e.g., as follows:

$$f = \frac{f 1 * f 2}{f 1 + f 2 - d} \qquad ( 6 )$$

In one example, the total focal length f may be determined based on the BFL and the particular viewing angle θ, for example, by combining Equation 5 and Equation 6, e.g., as follows:

$$f = \frac{f 1 * BFL}{f 1 - d} = φ * BFL , φ = \frac{f 1}{f 1 - d} \qquad ( 7 )$$

In one example, the focal length f1 of the first folding surface 311 may be defined based on a first curvature, denoted c1, of the first folding surface 311, and/or based on a first radius denoted R1, of the first folding surface 311, e.g., as follows:

$$f 1 = \frac{R 1}{2} = \frac{1}{2 c 1} \qquad ( 8 )$$

In one example, the focal length f2 of the second folding surface 321 may be defined based on a second curvature, denoted c2, of the second folding surface 321, and/or based on a second radius denoted R2, of the second folding surface 321, e.g., as follows:

$$f 2 = \frac{R 2}{2} = \frac{1}{2 c 2} \qquad ( 9 )$$

In one example, the BFL of the optical system 300 for the particular viewing angle θ may be determined, for example, based on a term w and the focal length f2 of the second folding surface 321, e.g., as follows:

$$B F L = \frac{ω}{1 + ω / f 2} , ω = f 1 - d \qquad ( 10 )$$

In some demonstrative aspects, the optical system 300 may build an image point, for example, for each viewing angle in the FoV of optical system 300.

In some demonstrative aspects, a system field curvature surface of the optical system 300, e.g., system field curvature surface 192 (FIG. 1), may include all such image points corresponding to all viewing angles in the FoV of optical system 300.

In one example, the system field curvature surface of the optical system 300 may include a Petzval surface, for example, when the optical surfaces 321 and 311 are spherical.

In one example, a radius of the Petzval surface, denoted Rp, of the optical system 300 may be determined, e.g., as follows:

$$Rp = \frac{f 1 * f 2}{f 1 + f 2} \qquad ( 11 )$$

According to this example, the radius Rp of the Petzval surface may be infinite, and the Petzval surface may be flat, for example, when the optical surfaces 321 and 311 have the same focal length and/or the same radius of curvature, e.g., f1=−f2.

In one example, the curvature of the Petzval surface may be convex towards the optical surfaces 321 and 311, for example, when the focal length f1 of the first folding surface 311 is positive, the focal length f2 of the second folding surface 321 is negative, and an absolute value of the focal length f1 is lower than the absolute value of the focal length f2, e.g., abs(f1)<abs(f2).

In some demonstrative aspects, a focal length, a curvature, and/or a radius at a particular point, e.g., corresponding to a particular viewing angle θ, of an aspherical folding surface, e.g., the first folding surface 311 and/or the second folding surface 321, may be locally approximated by a sphere.

For example, the focal length, the curvature, and/or the radius at a particular point of an aspherical surface may include a respective focal length, curvature, and/or radius of the sphere.

In one example, the sphere may be decentered from the optical axis 309 and may be shifted up or down, for example, such that the sphere is tangent to the folding surface at the particular point.

In some demonstrative aspects, as shown in FIG. 3B, a focal length, a curvature, and/or a radius of the first folding surface 311 at the first point P1, e.g., corresponding to the particular viewing angle θ, may be locally approximated by a sphere 301.

In one example, a curvature of the first folding surface 311 at the first point P1 may be approximated by the sphere 301, which may have a constant curvature, which is the same as the curvature of the first folding surface 311 at the point P1. According to this example, reflection of rays by the first folding surface 311 at the point P1 may be equivalent to reflection of the rays at the point P1 by the sphere 301, which may be decentered from the optical axis 309 and shifted up.

In some demonstrative aspects, as shown in FIG. 3C, a focal length, a curvature, and/or a radius of the second folding surface 321 at the second point P2, e.g., corresponding to the particular viewing angle θ, may be locally approximated by a sphere 302.

In one example, a curvature of the second folding surface 321 at the second point P2 may be approximated by the sphere 302, which may have a constant curvature, which may be the same as the curvature of the second folding surface 321 at the point P2. According to this example, reflection of rays by the second folding surface 321 at the point P2 may be equivalent to reflection of the rays at the point P2 by the sphere 302, which may be decentered from the optical axis 309 and shifted up.

In some demonstrative aspects, Equations 4-11 may be locally applied to any particular viewing angle θ, for example, based on spheres 301 and 302 corresponding to the particular viewing angle θ.

In some demonstrative aspects, Equations 4-11 may be locally applied to the sphere 301 and/or to the sphere 302 at the particular viewing angle θ, for example, when the first folding surface 311 and/or the second folding surface 321 are aspherical.

In some demonstrative aspects, a total focal length f, and a BFL of optical system 300 corresponding to the particular viewing angle θ may be determined, for example, based on Equations 4-11 utilizing the sphere 301 and/or the sphere 302.

In some demonstrative aspects, as shown in FIG. 3D, optical system 300 may be configured such that a first BFL, denoted BFL (h), corresponding to a first viewing angle may be shorter than a second BFL, denoted BFL(0), corresponding to a zero viewing angle.

In some demonstrative aspects, the PPD value of the optical system 300 may monotonically decrease with the increase in the viewing angle θ, for example, as the BFL decreases with the increase in the viewing angle θ.

In some demonstrative aspects, optical system 300 may be configured to provide a technical solution to support image quality over a large FoV, for example, as the field curvature surface 390 may be convex towards the eye 340.

In some demonstrative aspects, as shown in FIG. 3D, a field curvature surface 390 corresponding to a viewing angle θ may move closer to the eye, for example, with the increase in the viewing angle θ.

In some demonstrative aspects, as shown in FIG. 3D, a field curvature surface 390A corresponding to a viewing angle θ1 may be closer to the eye 340, for example, compared to a field curvature surface 390 corresponding to the viewing angle θ.

In some demonstrative aspects, as shown in FIG. 3D, a field curvature surface 390B corresponding to a viewing angle θ2 may be closer to the eye 340, for example, compared to the field curvature surface 390A corresponding to the viewing angle θ1.

In some demonstrative aspects, as shown in FIG. 3D, a field curvature surface 390 corresponding to a particular viewing angle θ may intersect a display surface of display 370 close to a relevant pixel location.

In some demonstrative aspects, as shown in FIG. 3D, field curvature surface 390 corresponding to the viewing angle θ may intersect the display 370 at, or close to, a pixel location 371, which is projected by optical system 300 to the viewing angle θ.

In some demonstrative aspects, as shown in FIG. 3D, field curvature surface 390A corresponding to the viewing angle θ1 may intersect the display 370 at, or close to, a pixel location 371A, which is projected by optical system 300 to the viewing angle θ1.

In some demonstrative aspects, as shown in FIG. 3D, field curvature surface 390B corresponding to the viewing angle θ2 may intersect the display 370 at, or close to, a pixel location 371B, which is projected by optical system 300 to the viewing angle θ2.

In some demonstrative aspects, as shown in FIG. 3D, optical system 300 may be configured, for example, such that an intersection of a field curvature surface 390 corresponding to a particular viewing angle θ may be located at, or close to, a pixel location, which is projected by optical system 300 to the particular viewing angle θ. For example, this configuration may be implemented to provide a technical solution to increase focus and/or visual acuity of optical system 300.

In some demonstrative aspects, optical system 300 may be configured, for example, such that a lens field curvature surface, e.g., lens field curvature surface 192 (FIG. 1), of optical system 300 may be close to a display surface of display 370, for example, within a range defined by an acceptable depth of focus of the optical system 300.

In some demonstrative aspects, optical system 300 may be configured, for example, such that for any viewing angle θ, there may be a chief ray propagating from a center of the pupil 341 towards the display 370.

In some demonstrative aspects, the chief ray may be reflected by the first folding surface 311 at a first point, and by the second folding surface 321 at a second point.

In some demonstrative aspects, a curvature (C1) of the first folding surface 311 at the first point may include a curvature of a first sphere (Sph1).

In some demonstrative aspects, a surface portion of the first folding surface 311 at the first point may be approximated by the first sphere Sph1.

In some demonstrative aspects, a curvature (C2) of the second folding surface 321 at the second point may include a curvature of a second sphere (Sph2).

In one example, a surface portion of the second folding surface 321 at the second point may be approximated by the second sphere Sph2.

In some demonstrative aspects, a field curvature surface corresponding to the particular viewing angle θ may be formed by the first sphere Sph1 and the second sphere Sph2.

In some demonstrative aspects, the field curvature surface corresponding to the particular viewing angle θ may be convex towards the eye 340.

In some demonstrative aspects, optical system 300 may be configured such that, for example, over at least 20 percent of the FoV of the optical system 300, the field curvature surface corresponding to the particular viewing angle θ may move closer to the eye 340, for example, with the increase in the viewing angle θ.

In some demonstrative aspects, optical system 300 may be configured such that, for example, over at least 20 percent of the FoV of the optical system 300, the total focal length of optical system 300 based on the first sphere Sph1 and the second sphere Sph2 may monotonically decrease with the increase in the viewing angle θ.

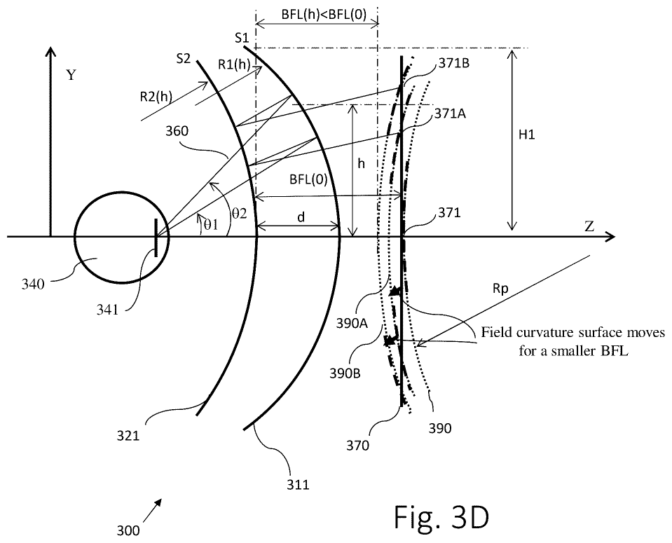

Reference is made to FIG. 4A, which schematically illustrates a graph 401 depicting a total focal length of an optical system based on a first parameter, to FIG. 4B, which schematically illustrates a graph 402 depicting the total focal length of the optical system based on a second parameter, and to FIG. 4C, which schematically illustrates a graph 403 depicting a BFL of the optical system, in accordance with some demonstrative aspects.

In some demonstrative aspects, graph 401 may depict the total focal length f of optical system 300 (FIG. 3), for example, based on first values of the first focal length f1 of the first folding surface 311 (FIG. 3), and the second focal length f2 of the second folding surface 321 (FIG. 3).

In some demonstrative aspects, graph 402 may depict the total focal length f of optical system 300 (FIG. 3), for example, based on second values of the first focal length f1 of the first folding surface 311 (FIG. 3), and the second focal length f2 of the second folding surface 321 (FIG. 3).

In some demonstrative aspects, graph 403 may depict the BFL of optical system 300 (FIG. 3), for example, based on different values of the term w.

In some demonstrative aspects, graph 401 depicts the total focal length f of the optical system 300 (FIG. 3), for example, according to Equation (6), for example, with the first focal length f1 of the first folding surface 311 (FIG. 3) as a variable, and the second focal length f2 of the second folding surface 321 (FIG. 3) is negative.

In some demonstrative aspects, as shown in FIG. 4A, a curve 412 depicts the total focal length f of the optical system 300 (FIG. 3), for example, with the first focal length f1 of the first folding surface 311 (FIG. 3) as a variable, and the absolute value of the second focal length f2 of the second folding surface 321 (FIG. 3) is equal to a first value.

In some demonstrative aspects, as shown in FIG. 4A, a curve 413 depicts the total focal length f of the optical system 300 (FIG. 3), for example, with the first focal length f1 of the first folding surface 311 (FIG. 3) as a variable, and the absolute value of the second focal length f2 of the second folding surface 321 (FIG. 3) is equal to a second value, which is lower than the first value.

In some demonstrative aspects, as shown in FIG. 4A, the total focal length f of the optical system 300 (FIG. 3) may approach an asymptotic line 411, at which the total focal length f may be sustainably equal to the first focal length f1, e.g., f=f1, for example, when an absolute value of the second focal length f2 increases towards infinity.

In some demonstrative aspects, as shown by curves 412 and 413 (FIG. 4A), the total focal length f may decrease with a decrease in the first focal length f1. For example, this function may be utilized to provide a technical solution to support configuration of the PPD value of the optical system 300 (FIG. 3) to monotonically decrease with the increase in the viewing angle θ.

In some demonstrative aspects, as shown in FIG. 4B, a curve 414 depicts the total focal length of the optical system 300 (FIG. 3), for example, according to Equation (6), for example, with the first focal length f1 of the first folding surface 311 (FIG. 3) as a variable, and where the second focal length f2 of the second folding surface 321 (FIG. 3) is positive.

In some demonstrative aspects, as shown in FIG. 4C, a curve 416 of graph 403 depicts the BFL of the optical system 300 (FIG. 3), for example, according to Equation (10), for example, based on the term ω.

For example, as described above, the term @ may be based on the first focal length f1, e.g., ω=f1-d.

In some demonstrative aspects, as shown by curve 416, the BFL may decrease with a decrease in the term @.

In some demonstrative aspects, the BFL may have a range of values, for example, between a BFL, denoted BFL0, corresponding to a zero viewing angle and a BFL, denoted BFLp, corresponding to a peripheral viewing angle.

In one example, the BFL0 corresponding to the zero viewing angle may be configured to ensure reasonable placement of the display 370 (FIG. 3). For example, display 370 (FIG. 3) may be placed not too far and not too close to the optical system 300 (FIG. 3), for example, in a range between ˜0.1 millimeter (mm) and 5 mm or any other range.

In some demonstrative aspects, as shown in FIG. 4C, a value of the BFL may be zero, e.g., BFL=0. For example, when the term w is zero, the first focal length f1 may be equal to the distance d, e.g., w=0, f1=d, and a back-propagated beam 430 from the eye pupil 442 may be focused on a folding surface 421, e.g., at a point 432.

In some demonstrative aspects, optical system 300 may be configured such that, the BFL may decrease with the increase in the viewing angle θ, for example, to move closer the field curvature 390 (FIG. 3), for example, such that the BFL (h) may be smaller than the BFL(0).

In some demonstrative aspects, as shown in FIG. 4C, and in accordance with Equation (10), the decrease of the BFL may be, for example, due to a decrease of the first focal length f1 with the increase in the viewing angle θ.

In some demonstrative aspects, as shown by curves 412 and 413 (FIG. 4A), the decrease of the first focal length f1 may result in a decrease in the total focal length f.

In some demonstrative aspects, the PPD of the optical system 300 (FIG. 3) may monotonically decrease with the increase in the viewing angle θ, for example, when the second folding surface 321 (FIG. 3) may be a sphere with a constant curvature, and the curvature of the first folding surface 311 (FIG. 3) may monotonically increase.

In some demonstrative aspects, the PPD of the optical system 300 (FIG. 3) may monotonically decrease with the increase in the viewing angle θ, for example, when the second folding surface 321 (FIG. 3) is a sphere with a constant curvature, and the first focal length f1 monotonically decreases with the increase in the viewing angle θ.

In one example, there may be a limited range of possible changes of the first focal length f1, which may be implemented in order to result in the monotonic decrease in the PPD. For example, large optical aberrations and/or difficulties in manufacturing may occur, for example, when the first folding surface 311 (FIG. 3) becomes too much curved, for example, as a result of the change in the first focal length f1.

In some demonstrative aspects, the curvature of the second folding surface 321 (FIG. 3) may be changed, e.g., in addition to the changes in curvature of the first folding surface 311 (FIG. 3), for example, in order to achieve more design freedom.

In some demonstrative aspects, there may be one or more technical issues in a configuration in which the curvature of the second folding surface 321 (FIG. 3) may increase with the increase in the viewing angle θ.

For example, the absolute value of the second focal length f2 may decrease with the increase in the viewing angle θ, for example, as an absolute value of the curvature of the second folding surface 321 (FIG. 3) increases.

According to this example, as shown by curves 412 and 413, the total focal length f may increase with the decrease in the absolute value of the second focal length f2.

According to this example, as shown in FIG. 4C and in accordance with Equation 10, the BFL may increase with the increase in the viewing angle θ, and with the decrease in the absolute value of the second focal length f2.

For example, the increase in the BFL may make it difficult to compensate for the field curvature 390 (FIG. 3). According to this example, the configuration in which the absolute value of the curvature of the second folding surface 321 (FIG. 3) increases with the increase in the viewing angle θ may provide a reduced image quality, and may not be able to sufficiently support a decrease of PPD with the increase in the viewing angle θ.

In some demonstrative aspects, the absolute value of the curvature of the second folding surface 321 (FIG. 3) may decrease with the increase in the viewing angle θ.

In some demonstrative aspects, the curvature of first folding surface 311 (FIG. 3) may decrease, increase, or remain constant, for example, when the absolute value of the curvature of the second folding surface 321 (FIG. 3) decreases.

In some demonstrative aspects, the absolute value of the second focal length f2 may increase with the increase in the viewing angle θ, for example, as the absolute value of the curvature of the second folding surface 321 (FIG. 3) decreases with the increase in the viewing angle θ.

In some demonstrative aspects, the first focal length f1 may decrease with the increase in the viewing angle θ, and the absolute value of the second focal length f2 may increase, for example, with the increase in the viewing angle θ.

In some demonstrative aspects, as shown by curves 412 and 413 (FIG. 4A), the total focal length f may decrease, for example, when the first focal length f1 decreases with the increase in the viewing angle θ, and the absolute value of the second focal length f2 increases with the increase in the viewing angle θ

In some demonstrative aspects, a radius of a field curvature surface may decrease and the BFL may also decrease, for example, when the first focal length f1 decreases with the increase in the viewing angle θ, and the absolute value of the second focal length f2 increases with the increase in the viewing angle θ.

In some demonstrative aspects, a configuration of optical system 300 (FIG. 3) in which the first focal length f1 decreases with the increase in the viewing angle θ and the absolute value of the second focal length f2 increases with the increase in the viewing angle θ may provide a technical solution to support a decrease in the PPD of the optical system 300 with the increase in the viewing angle.

In some demonstrative aspects, the first focal length f1 may remain constant and the absolute value of the second focal length f2 may increase, for example, with the increase in the viewing angle θ.

In some demonstrative aspects, as shown by curves 412 and 413 (FIG. 4A), the total focal length f may decrease, for example, when the first focal length remains constant, and the absolute value of the second focal length f2 increases with the increase in the viewing angle θ. However, for a same increase of the absolute value of the second focal length f2, a decrease rate of the total focal length f may be less, than the decrease rate of the total focal length fin the configuration, in which the first focal length f1 decreases with the increase in the viewing angle θ.

In some demonstrative aspects, a configuration of optical system 300 (FIG. 3) in which the first focal length f1 remains constant and the absolute value of the second focal length f2 increases with the increase in the viewing angle θ may provide a technical solution to support a decrease in the PPD of the optical system 300 (FIG. 3) with the increase in the viewing angle θ. However, a decrease rate of the PPD with the increase in the viewing angle θ may be lower, for example, compared to the configuration of the optical system 300 (FIG. 3), in which the first focal length f1 decreases with the increase in the viewing angle θ.

In some demonstrative aspects, the first focal length f1 may increase with the increase in the viewing angle θ, and the absolute value of the second focal length f2 may increase, for example, with the increase in the viewing angle θ.

In some demonstrative aspects, an increase rate of the increase of the absolute value of the second focal length f2 may be greater than an increase rate of the increase in the first focal length f1, for example, to support a decrease in the total focal length, for example, according to Equation 6 and curves 412 and 413 (FIG. 4A).

In some demonstrative aspects, the BFL may be configured to decrease with the increase in the viewing angle θ, for example, when the first focal length f1 increases with the increase in the viewing angle θ, for example, to support a balancing field curvature.

In some demonstrative aspects, a configuration of optical system 300 (FIG. 3) in which the first focal length f1 may increase with the increase in the viewing angle θ and the absolute value of the second focal length f2 may increase with the increase in the viewing angle θ, may provide a technical solution to support a decrease in the PPD of the optical system 300 with the increase in the viewing angle θ.

In some demonstrative aspects, the second folding surface 321 (FIG. 3) may include an inflection point, e.g., corresponding to a focal length of infinity, at which the curvature of the second folding surface 321 (FIG. 3) may be zero, and a sign of the curvature may be switched between negative and positive.

In some demonstrative aspects, the curvature of the second folding surface 321 (FIG. 3) may increase after the inflection point, for example, with the increase in the viewing angle θ.

In some demonstrative aspects, the second focal length f2 may be positive and may decrease after the inflection point with the increase in the viewing angle θ.

In some demonstrative aspects, as shown by curve 414 (FIG. 4B), the total focal length f may decrease, for example, with the decrease in the first focal length f1, for example, when the second focal length f2 is positive.

In some demonstrative aspects, the total focal length f may decrease with the increase in the first focal length f1, for example, as the second focal length f2 may decrease after the inflection point.

In some demonstrative aspects, a configuration in which the first focal length f1 may increase with the increase in the viewing angle θ after the inflection point, and the second focal length f2 may be positive and may decrease after the inflection point with the increase in the viewing angle θ, may provide a technical solution to support compensation of aberrations and/or balancing a field curvature surface.

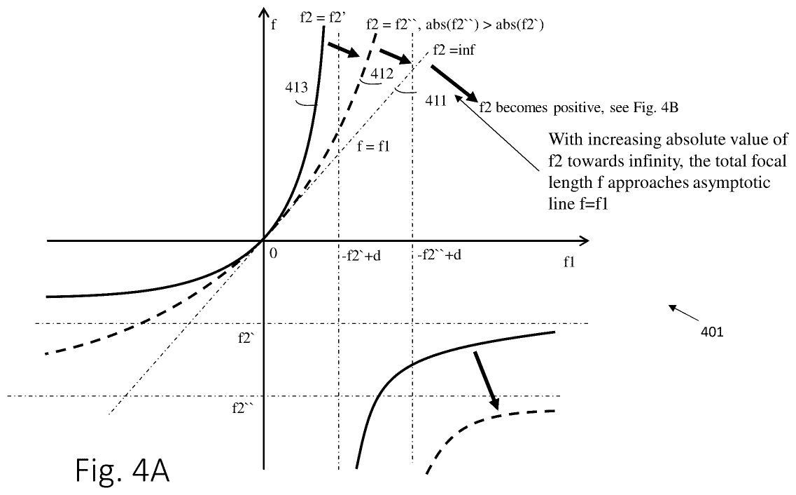

Reference is made to FIG. 5, which schematically illustrates an optical system 500, in accordance with some demonstrative aspects.

For example, system 101 (FIG. 1) and/or optical system 100 (FIG. 1) may include one or more elements of optical system 500, and/or may be configured to provide at least part of the functionality of optical system 500.

In some demonstrative aspects, as shown in FIG. 5, optical system 500 may be configured to direct light from a display 570 to an eye 540 of a user, for example, according to a catoptric optical mechanism 502.

In some demonstrative aspects, catoptric optical mechanism 502 may be configured, for example, according to the first configuration of the catoptric optical mechanism 102 (FIG. 1).

In some demonstrative aspects, as shown in FIG. 5, catoptric optical mechanism 502 may include a first folding surface 511.

In some demonstrative aspects, the first folding surface 511 may include an aspherical surface.

In some demonstrative aspects, as shown in FIG. 5, catoptric optical mechanism 502 may include a second folding surface 521.

In some demonstrative aspects, the second folding surface 521 may include a spherical surface.

In some demonstrative aspects, a curvature of the second folding surface 521 may be constant.

In some demonstrative aspects, a focal length of the second folding surface 521 may be constant and negative.

In some demonstrative aspects, the first folding surface 511 may be configured such that, for example, over at least 20 percent of the FoV of the optical system 500, a curvature of the first folding surface 521 may monotonically increase with an increase in a viewing angle θ of the eye 540.

In some demonstrative aspects, optical system 500 may be configured, for example, to provide a technical solution to support wide FoV systems. For example, the first folding surface 511 may fold the light towards an optical axis of the optical system 500 at large viewing angles, for example, due to a large angle between a normal 517 to the surface 511 and an optical axis 509 of the optical system 500, for example, at high values of the viewing angle θ.

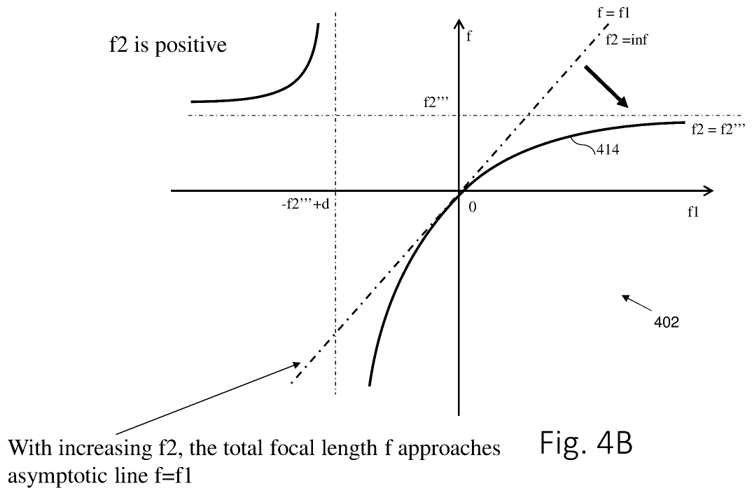

Reference is made to FIG. 6, which schematically illustrates an optical system 600, in accordance with some demonstrative aspects.

For example, system 101 (FIG. 1) and/or optical system 100 (FIG. 1) may include one or more elements of optical system 600, and/or may be configured to provide at least part of the functionality of optical system 600.

In some demonstrative aspects, as shown in FIG. 6, optical system 600 may be configured to direct light from a display 670 to an eye 640 of a user, for example, according to a catoptric optical mechanism 602.

In some demonstrative aspects, catoptric optical mechanism 602 may be configured, for example, according to the third configuration of the catoptric optical mechanism 102 (FIG. 1).

In some demonstrative aspects, as shown in FIG. 6, catoptric optical mechanism 602 may include a first folding surface 611.

In some demonstrative aspects, the first folding surface 611 may include a first aspherical surface.

In some demonstrative aspects, as shown in FIG. 6, catoptric optical mechanism 602 may include a second folding surface 621.

In some demonstrative aspects, the second folding surface 621 may include a second aspherical surface.

In some demonstrative aspects, the first folding surface 611 may be configured, for example, such that, for example, over at least 20 percent of the FoV of the optical system 600, the curvature of the first folding surface 611 may be positive and may monotonically increase with an increase in the viewing angle θ of the eye 640.

In some demonstrative aspects, the second folding surface 621 may be configured such that, for example, over at least 20 percent of a first range 631 of viewing angles between an optical axis 609 of the optical system 600 and an inflection point 619 on the second folding surface 621, the curvature of the second folding surface 621 may be negative and may monotonically increase with the increase in the viewing angle θ.

In some demonstrative aspects, the second folding surface 621 may be configured such that, for example, over at least 20 percent of a second range 632 of viewing angles between the inflection point 619 and an edge of the optical system 600, the curvature of the second folding surface 621 may be positive and may monotonically increase with the increase in the viewing angle θ.

In some demonstrative aspects, the second folding surface 621 may not include an inflection point.

In some demonstrative aspects, the second folding surface 612 may be configured such that, for example, over at least 20 percent of the FoV of the optical system 600, the curvature of the second folding surface 621 may be negative and may monotonically increase with the increase in the viewing angle θ of the eye 640.

In some demonstrative aspects, optical system 600 may be configured, for example, to provide a technical solution to support wide FoV systems. For example, the first folding surface 611 may fold the light towards the optical axis 609 of the optical system 600 at large viewing angles, for example, due to a large angle between a normal 617 to the surface 611 and the optical axis 609, for example, at high values of the viewing angle θ.

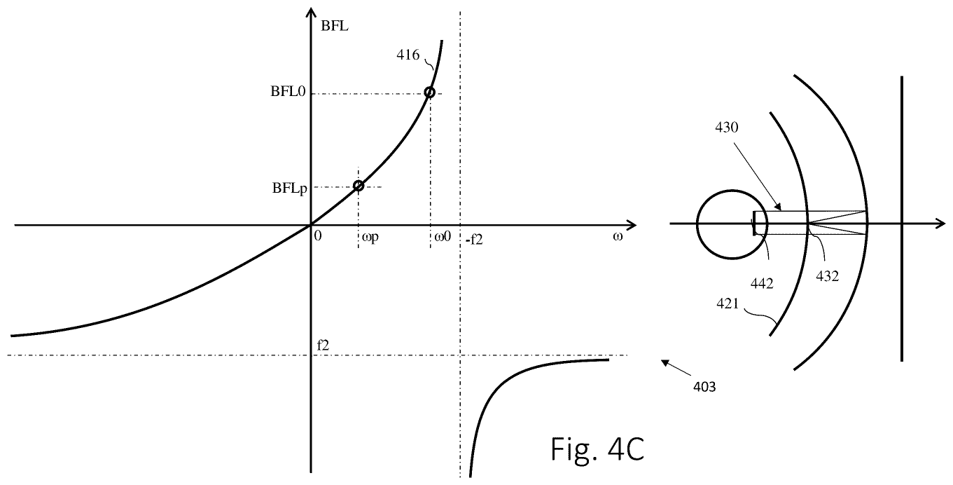

Reference is made to FIG. 7, which schematically illustrates an optical system 700, in accordance with some demonstrative aspects.

For example, system 101 (FIG. 1) and/or optical system 100 (FIG. 1) may include one or more elements of optical system 700, and/or may be configured to provide at least part of the functionality of optical system 700.

In some demonstrative aspects, as shown in FIG. 7, optical system 700 may be configured to direct light from a display 770 to an eye 740 of a user, for example, according to a catoptric optical mechanism 702.

In some demonstrative aspects, catoptric optical mechanism 702 may be configured, for example, according to the second configuration of the catoptric optical mechanism 102 (FIG. 1).

In some demonstrative aspects, as shown in FIG. 7, catoptric optical mechanism 702 may include a first folding surface 711.

In some demonstrative aspects, the first folding surface 711 may include a spherical surface.

In some demonstrative aspects, a curvature of first folding surface 711 may be constant.

In some demonstrative aspects, as shown in FIG. 7, catoptric optical mechanism 702 may include a second folding surface 721.

In some demonstrative aspects, the second folding surface 721 may include an aspherical surface.

In some demonstrative aspects, the second folding surface 721 may be configured such that, for example, over at least 20 percent of a first range 732 of viewing angles between an optical axis 709 of the optical system 700 and an inflection point 713 on the second folding surface 721, the curvature of the second folding surface 721 may be negative and may monotonically increase with an increase in a viewing angle θ of the eye 740.

In some demonstrative aspects, the second folding surface 721 may be configured such that, for example, over at least 20 percent of a second range 734 of viewing angles between the inflection point 713 and an edge of the optical system 700, the curvature of the second folding surface 721 may be positive and may monotonically increase with the increase in the viewing angle θ.

In some demonstrative aspects, the second folding surface 721 may not include an inflection point.

In some demonstrative aspects, the second folding surface 712 may be configured such that, for example, over at least 20 percent of the FoV of the optical system 700, the curvature of the second folding surface 721 may be negative and may monotonically increase with the increase in the viewing angle θ of the eye 740.

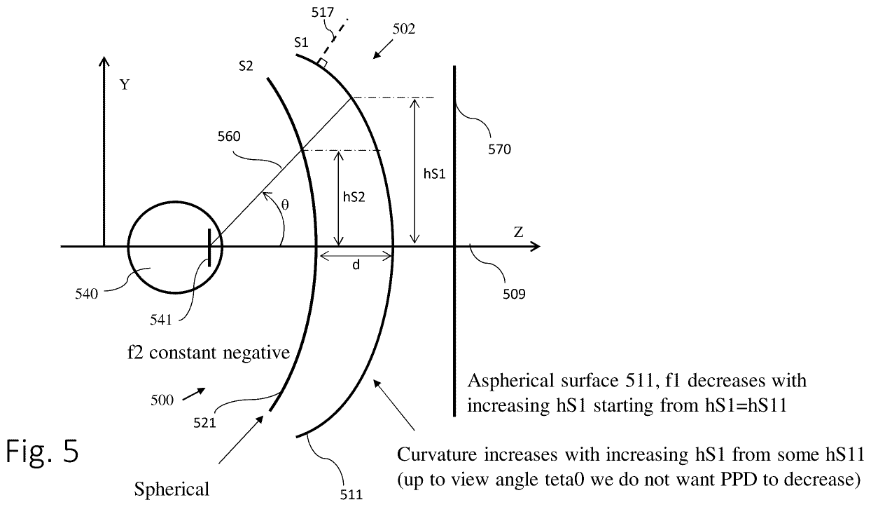

Reference is made to FIG. 8, which schematically illustrates an optical system 800, in accordance with some demonstrative aspects.

For example, system 101 (FIG. 1) and/or optical system 100 (FIG. 1) may include one or more elements of optical system 800, and/or may be configured to provide at least part of the functionality of optical system 800.

In some demonstrative aspects, as shown in FIG. 8, optical system 800 may be configured to direct light from a display 870 to an eye 840 of a user, for example, according to a catoptric optical mechanism 802.

In some demonstrative aspects, catoptric optical mechanism 802 may be configured, for example, according to the fourth configuration of the catoptric optical mechanism 102 (FIG. 1).

In some demonstrative aspects, as shown in FIG. 8, catoptric optical mechanism 802 may include a first folding surface 811.

In some demonstrative aspects, the first folding surface 811 may include a first aspherical surface.

In some demonstrative aspects, as shown in FIG. 8, catoptric optical mechanism 802 may include a second folding surface 821.

In some demonstrative aspects, the second folding surface 821 may include a second aspherical surface.

In some demonstrative aspects, the first folding surface 811 may be configured such that, for example, over at least 20 percent of the FoV of the optical system 800, the curvature of the first folding surface 811 may be positive and may monotonically decrease with an increase in the viewing angle θ of the eye 840.

In some demonstrative aspects, the second folding surface 821 may be configured such that, for example, over at least 20 percent of the FoV of the optical system 800, the curvature of the second folding surface 821 may be negative and may monotonically increase with the increase in the viewing angle θ of the eye 840.

In some demonstrative aspects, an increase rate of the curvature of the second folding surface 821 may be greater than a decrease rate of the curvature of the first folding surface 811.

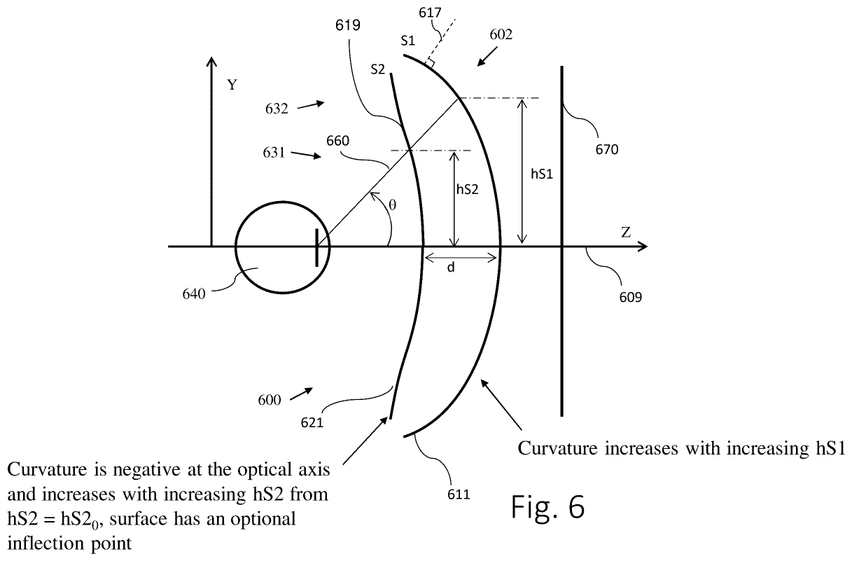

Reference is made to FIG. 9, which schematically illustrates an optical system 900, in accordance with some demonstrative aspects.

For example, system 101 (FIG. 1) and/or optical system 100 (FIG. 1) may include one or more elements of optical system 900, and/or may be configured to provide at least part of the functionality of optical system 900.

In some demonstrative aspects, as shown in FIG. 9, optical system 900 may be configured to direct light from a display 970 to an eye 940 of a user, for example, according to a catoptric optical mechanism 902.

In some demonstrative aspects, catoptric optical mechanism 902 may be configured, for example, according to the fifth configuration of the catoptric optical mechanism 102 (FIG. 1).

In some demonstrative aspects, as shown in FIG. 9, catoptric optical mechanism 902 may include a first folding surface 911.

In some demonstrative aspects, the first folding surface 911 may include a first aspherical surface.

In some demonstrative aspects, as shown in FIG. 9, catoptric optical mechanism 902 may include a second folding surface 921.

In some demonstrative aspects, the second folding surface 921 may include a second aspherical surface.

In some demonstrative aspects, the first folding surface 911 may be configured such that, for example, over at least 20 percent of a first range 931 of viewing angles between an optical axis 909 of the optical system 900 and a first inflection point 913 on the first folding surface 911, a curvature of the first folding surface 911 may be positive and may monotonically decrease with an increase in a viewing angle θ of the eye 940.

In some demonstrative aspects, the first folding surface 911 may be configured such that, for example, over at least 20 percent of a second range 932 of viewing angles between the first inflection point 913 and an edge of the optical system 900, the curvature of the first folding surface 911 may be negative and may monotonically decrease with the increase in the viewing angle θ.

In some demonstrative aspects, the second folding surface 921 may be configured such that, for example, over at least 20 percent of a third range 933 of viewing angles between the optical axis 909 of the optical system 900 and a second inflection point 915 on the second folding surface 921, the curvature of the second folding surface 921 may be negative and may monotonically increase with the increase in the viewing angle θ.

In some demonstrative aspects, the second folding surface 921 may be configured such that, for example, over at least 20 percent of a fourth range 934 of viewing angles between the second inflection point 915 and the edge of the optical system 900, the curvature of the second folding surface 921 may be positive and may monotonically increase with the increase in the viewing angle θ.

In some demonstrative aspects, a rate of change in the curvature of the first folding surface 911 may be greater than a rate of change in the curvature of the second folding surface 921.

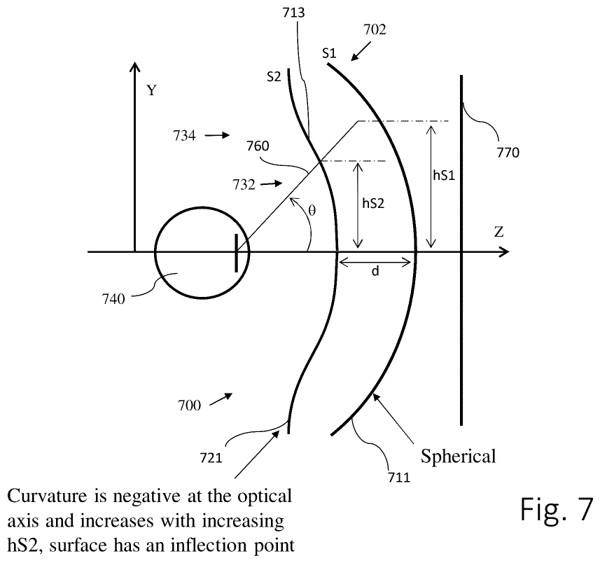

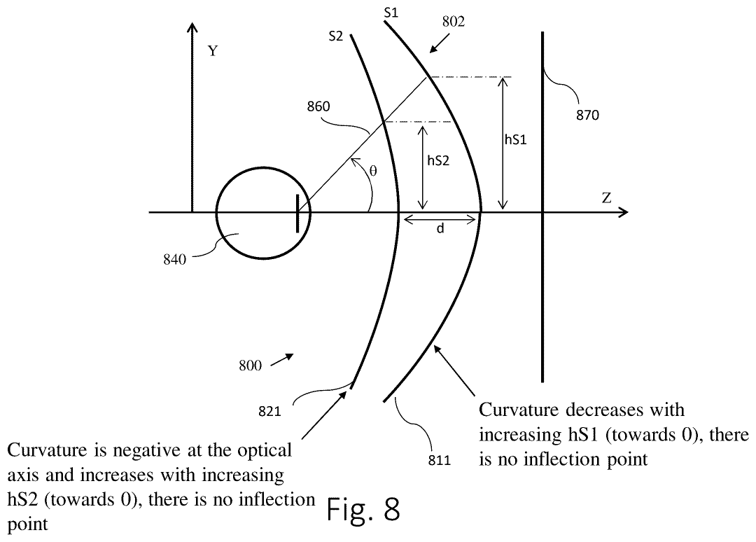

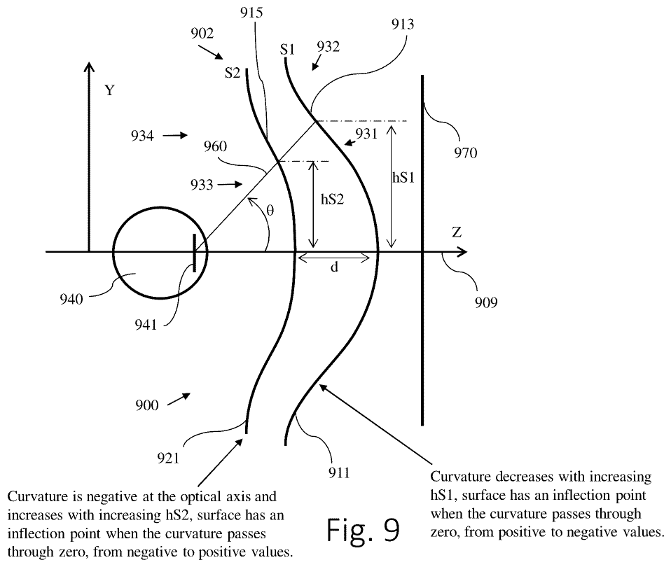

Reference is made to FIG. 10A, which schematically illustrates an optical system 1000, and to FIG. 10B, which schematically illustrates a catoptric optical mechanism 1002 of the optical system 1000, in accordance with some demonstrative aspects.

For example, system 101 (FIG. 1) and/or optical system 100 (FIG. 1) may include one or more elements of optical system 1000, and/or may be configured to provide at least part of the functionality of optical system 1000.

In some demonstrative aspects, optical system 1000 may be configured to direct light from a display 1070 to an eye 1040 of a user, for example, according to the catoptric optical mechanism 1002.

In some demonstrative aspects, as shown in FIG. 10A, optical system 1000 may include a single lens 1010.

In some demonstrative aspects, as shown in FIG. 10A, single lens 1010 may include a first optical surface 1051.

In some demonstrative aspects, as shown in FIG. 10, single lens 1010 may include a second optical surface 1052, for example, opposite to the first optical surface 1051.

In one example, the single lens 1010 may be a practical configuration, for example, with respect to a manufacturing process of the single lens.

In one example, the single lens 1010 may be made of glass, an optical plastic material, and/or any other material.

In some demonstrative aspects, optical system 1000 may be configured such that, for example, over at least 20 percent of a FoV of the optical system 1000, a BFL of optical system 1000 may monotonically decrease with an increase in a viewing angle θ of the eye 1040, e.g., as described above.

In some demonstrative aspects, optical system 1000 may be configured such that, for example, over at least 20 percent of a FoV of the optical system 1000, a PPD of optical system 1000 may monotonically decrease with the increase in the viewing angle θ, e.g., as described above.

In some demonstrative aspects, the first optical surface 1051 and the second optical surface 1052 may be configured to direct the light from the display to the eye 1040 of the user according to the catoptric optical mechanism 1002, for example, based on refraction of light 1071 from the display 1070 by the first optical surface 1051, for example, to provide first refracted light 1072 towards the second optical surface 1052.

In some demonstrative aspects, the first optical surface 1051 and the second optical surface 1052 may be configured to direct the light from the display to the eye 1040 of the user according to the catoptric optical mechanism 1002, for example, based on reflection of the first refracted light 1072 by the second optical surface 1052, for example, to provide first reflected light 1073 towards the first optical surface 1051.

In some demonstrative aspects, the first optical surface 1051 and the second optical surface 1052 may be configured to direct the light from the display to the eye 1040 of the user according to the catoptric optical mechanism 1002, for example, based on reflection of the first reflected light 1073 by the first optical surface 1051, for example, to provide second reflected light 1074 towards the second optical surface 1052.

In some demonstrative aspects, the first optical surface 1051 and the second optical surface 1052 may be configured to direct the light from the display to the eye 1040 of the user according to the catoptric optical mechanism 1002, for example, based on refraction of the second reflected light 1074 by the second optical surface 1052, for example, to provide second refracted light 1075 towards the eye 1040.

In some demonstrative aspects, as shown in FIG. 10B, catoptric optical mechanism 1002 may include a first folding surface 1011.

In some demonstrative aspects, as shown in FIG. 10B, catoptric optical mechanism 1002 may include a second folding surface 1021.

In some demonstrative aspects, a first curvature of the first folding surface 1011 at a particular viewing angle θ may be based, for example, on a reflective optical power of the first optical surface 1051 to provide the second reflected light 1074 towards the second optical surface 1052 for the particular viewing angle θ.

In some demonstrative aspects, the first curvature of the first folding surface 1011 at the particular viewing angle θ may be based, for example, on a refractive optical power of the second optical surface 1052 to provide the second refracted light 1075 towards the eye 1040 for the particular viewing angle θ.

In some demonstrative aspects, the second curvature of the second folding surface 1021 corresponding to the particular viewing angle θ may be based, for example, on a reflective optical power of the second optical surface 1052 to provide the first reflected light 1073 towards the first optical surface 1051 for the particular viewing angle θ.

In some demonstrative aspects, the second curvature of the second folding surface 1021 corresponding to the particular viewing angle θ may be based, for example, on a refractive optical power of the first optical surface 1051 to provide the first refracted light 1072 towards the second optical surface 1052 for the particular viewing angle θ.

In some demonstrative aspects, catoptric optical mechanism 1002 may include a simplified version of optical system 1000, which may be determined, for example, based on a system of equations of thin lenses.

In some demonstrative aspects, a refraction by a first optical surface and a following reflection by a second optical surface may be reduced, for example, to a reflection from a first folding surface, for example, based on a system of equations of thin lenses.

In some demonstrative aspects, a reflection by a first optical surface and a following refraction by a second optical surface may be reduced, for example, to a reflection from a second folding surface, for example, based on the system of equations of thin lenses.

In some demonstrative aspects, first folding surface 1011 and/or second folding surface 1021 may be determined, for example, based on the system of equations of thin lenses, which may be applied to the single lens 1010, for example, based on a propagation of a light ray 1060, for example, in a backward ray-tracing.

In some demonstrative aspects, as shown in FIG. 10A, the light ray 1060 may propagate from an eye pupil 1041 of the eye 1040 towards the display 1070, for example, in a backward ray-tracing.

In some demonstrative aspects, as shown in FIG. 10A, the light ray 1060 may be refracted by the optical surface 1052, e.g., at a point P2A.

In some demonstrative aspects, as shown in FIG. 10A, the light ray 1060 may be reflected by the optical surface 1051, e.g., at a point P1A.

In some demonstrative aspects, as shown in FIG. 10A, the light ray 1060 may be reflected by the optical surface 1052, e.g., at a point P2B.

In some demonstrative aspects, as shown in FIG. 10A, the light ray 1060 may be refracted by the optical surface 1051, e.g., at a point P1B, towards the display 1070.

In some demonstrative aspects, as shown in FIGS. 10A and 10B, the refraction of the light ray 1060 by the second optical surface 1052, e.g., at the point P2A, and the reflection of the light ray 1060 from the first optical surface 1051, e.g., at the point P1A, may be reduced, for example, to a reflection of the light ray 1060 from the first folding surface 1011, e.g., at a point P1.

In some demonstrative aspects, as shown in FIGS. 10A and 10B, the reflection of the light ray 1060 from the second optical surface 1052, e.g., at the point P2B, and the refraction of the light ray 1060 by the first optical surface 1051, e.g., at the point P1B may be reduced, for example, to a reflection the light ray 1060 from the second folding surface 1021, e.g., at a point P2.

In some demonstrative aspects, as shown in FIG. 10B, catoptric optical mechanism 1002 may include only two folding surfaces, which may be equivalent to optical system 1000, for example, for a light ray 1060, e.g., for any light ray 1060, in optical system 1000, in a direction of a particular viewing angle θ.

Reference is made to FIG. 10C, which schematically illustrates a construction scheme to demonstrate a construction of the first folding surface 1011 and the second folding surface 1021 from the optical system 1000, in accordance with some demonstrative aspects.

In some demonstrative aspects, a first reflective focal length, denoted f_{P1A}, of the first folding surface 1011 at the point P1A may be determined, e.g., as follows:

$${f}_{P 1 A} = 1 / ( 2 n * {C}_{P 1 A} ) \qquad ( 12 )$$

wherein n denotes a refractive optical power of a lens material of single lens 1010, and CPIA denotes a curvature of the first folding surface 1011 at the point P1A.

In some demonstrative aspects, a second refractive focal length, denoted f_{P2A}, of the second folding surface 1021 at the point P2A may be determined, e.g., as follows:

$${f}_{P 2 A} = 1 / ( ( n - 1 ) * {C}_{P 2 A} ) \qquad ( 13 )$$

wherein C_{P2A} denotes a curvature of the second folding surface 1021 at the point P2A.

In some demonstrative aspects, a first combined focal length, denoted f1, based on the first reflective focal length f_{P1A} and the second refractive focal length f_{P2A}, may be determined, for example, based on the refraction at the point P2A and the reflection at the point P1A, for example, using a thin lens equation, e.g., as follows:

$$\frac{1}{f 1} = \frac{1}{{f}_{P 2 A}} + \frac{1}{{f}_{P 1 A}} - \frac{d 1}{{f}_{P 2 A} {f}_{P 1 A}} \qquad ( 14 )$$

wherein d1 denotes a distance between the first point P1A and the second point P2A.

In some demonstrative aspects, the combined focal length f1 may define the first curvature of the first folding surface 1011 at the point P1.

In some demonstrative aspects, a portion of a sphere, denoted SIB, may have the combined focal length f1. Accordingly, the portion of the sphere SIB may have the first curvature of the first folding surface 1011 at the point P1.

In some demonstrative aspects, as shown in FIG. 10C, the portion of the sphere SIB may be at the point P1.

In some demonstrative aspects, as shown in FIG. 10C, the point P1 may include an intersection between a first ray 1063 and a second ray 1064.

In some demonstrative aspects, the first ray 1063 may include a continuation of the ray 1060.

In some demonstrative aspects, the second ray 1064 may include the first reflected light 1073.

In some demonstrative aspects, a first refractive focal length, denoted f_{P1B}, of the first folding surface 1011 at the point P1B may be determined, for example, similar to the first refractive focal length f_{P2A}.

In some demonstrative aspects, a second reflective focal length, denoted f_{P2B}, of the second folding surface 1021 at the point P2B may be determined, for example, similar to the first reflective focal length f_{P1A}.

In some demonstrative aspects, a second combined focal length, denoted f2, based on the first refractive focal length f_{P1B} and the second reflective focal length f_{P2B} may be determined, for example, based on the refraction at the point P1B and the reflection at the point P2B, for example, using a thin lens equation, for example, similar to the combined focal length f1.

In some demonstrative aspects, the second combined focal length f2 may define the second curvature of the second folding surface 1021 at the point P2.

In some demonstrative aspects, a portion of a sphere, denoted S2B, may have the combined focal length f2. Accordingly, the portion of the sphere S2B may have the second curvature of the second folding surface 1021 at the point P2.

In some demonstrative aspects, as shown in FIG. 10C, the portion of the sphere S2B may be at the point P2.

In some demonstrative aspects, as shown in FIG. 10C, the point P2 may include an intersection between the second ray 1064 and a third ray 1065.

In some demonstrative aspects, as shown in FIG. 10C, the third ray 1065 may include a continuation of a ray 1069, which may include the light 1071 from the display 1070.

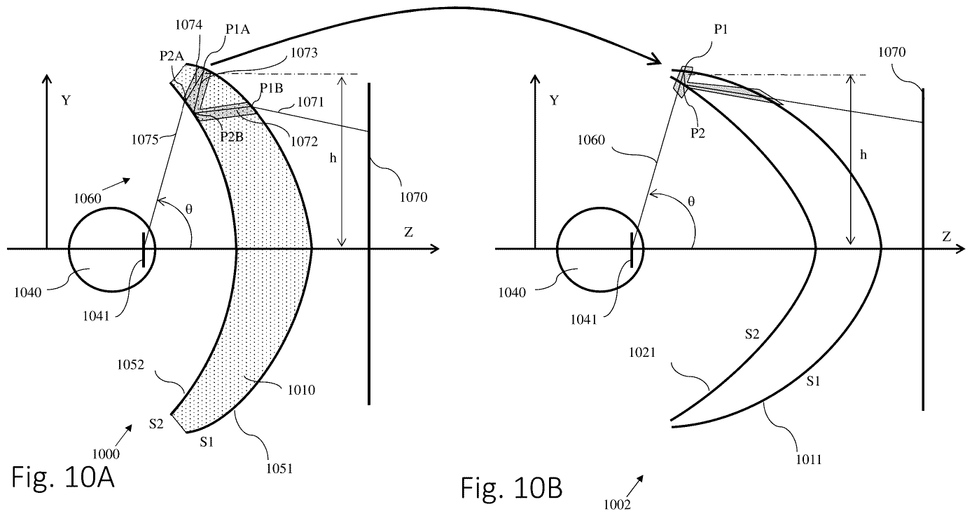

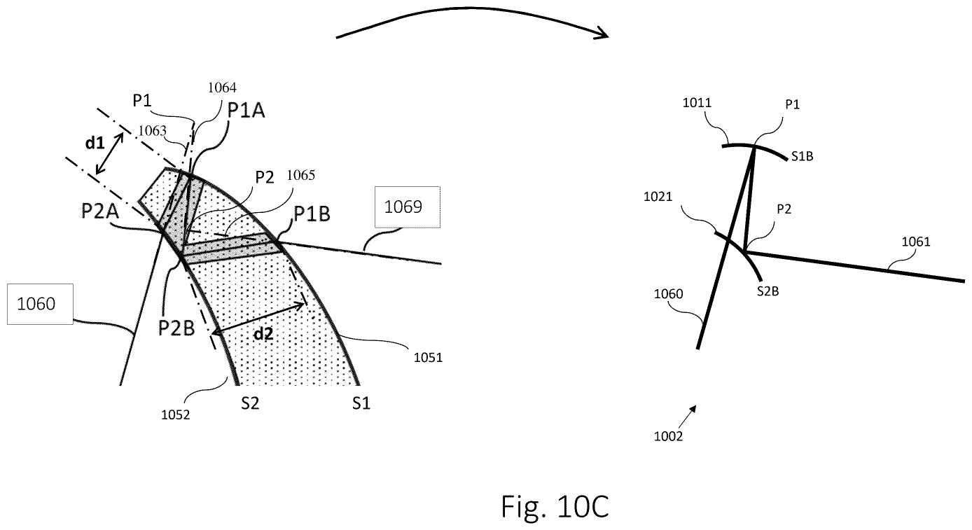

Reference is made to FIG. 11A, which schematically illustrates an optical system 1100, and to FIG. 11B, which schematically illustrates the system 1101 including a catoptric optical mechanism 1102 of the optical system 1100, in accordance with some demonstrative aspects.

For example, system 101 (FIG. 1) and/or optical system 100 (FIG. 1) may include one or more elements of optical system 1100, and/or may be configured to provide at least part of the functionality of optical system 1100.

In some demonstrative aspects, optical system 1100 may be configured to direct light 1171 from a display 1170 to an eye 1140 of a user, for example, according to the catoptric optical mechanism 1102.

In some demonstrative aspects, as shown in FIG. 11A, optical system 1100 may include a single lens 1110.

In some demonstrative aspects, as shown in FIG. 11A, single lens 1110 may include an optical surface 1151.

In some demonstrative aspects, as shown in FIG. 11, single lens 1110 may include a refractive surface 1152 opposite to the optical surface 1151.

In some demonstrative aspects, as shown in FIG. 11, single lens 1110 may include a folding layer 1153 between the optical surface 1151 and the refractive surface 1152.

In one example, the single lens 1110 may be a practical configuration, for example, with respect to a manufacturing process of the single lens.

In one example, the single lens 1110 may be made of glass, an optical plastic material, and/or any other material.

In some demonstrative aspects, optical system 1100 may be configured such that, for example, over at least 20 percent of a FoV of the optical system 1100, a BFL of optical system 1100 may monotonically decrease with an increase in a viewing angle θ of the eye 1140, e.g., as described above.

In some demonstrative aspects, optical system 1100 may be configured such that, for example, over at least 20 percent of a FoV of the optical system 1100, a PPD of optical system 1100 may monotonically decrease with the increase in the viewing angle θ, e.g., as described above.

In some demonstrative aspects, as shown in FIG. 11A, single lens 1110 may be configured to direct the light 1171 from the display 1170 to the eye 1140 of the user according to the catoptric optical mechanism 1102, for example, based on refraction of the light 1171 from the display 1170 by the optical surface 1151, for example, to provide first refracted light 1172 towards the folding layer 1153.

In some demonstrative aspects, as shown in FIG. 11A, single lens 1110 may be configured to direct the light 1171 from the display 1170 to the eye 1140 of the user according to the catoptric optical mechanism 1102, for example, based on reflection of the first refracted light 1172 by the folding layer 1153, for example, to provide first reflected light 1173 towards the optical surface 1151.

In some demonstrative aspects, as shown in FIG. 11A, single lens 1110 may be configured to direct the light 1171 from the display 1170 to the eye 1140 of the user according to the catoptric optical mechanism 1102, for example, based on reflection of the first reflected light 1173 by the optical surface 1151, for example, to provide second reflected light 1174 towards the folding layer 1153.

In some demonstrative aspects, as shown in FIG. 11A, single lens 1110 may be configured to direct the light 1171 from the display 1170 to the eye 1140 of the user according to the catoptric optical mechanism 1102, for example, based on transfer of the second reflected light 1174 by the folding layer 1153 towards the refractive surface 1152.

In some demonstrative aspects, as shown in FIG. 11A, single lens 1110 may be configured to direct the light 1171 from the display 1170 to the eye 1140 of the user according to the catoptric optical mechanism 1102, for example, based on refraction of the second reflected light 1174 by the refractive surface 1152, for example, to provide second refracted light 1175 towards the eye 1140.

In some demonstrative aspects, as shown in FIG. 11B, catoptric optical mechanism 1102 may include a first folding surface 1111.

In some demonstrative aspects, as shown in FIG. 11B, catoptric optical mechanism 1102 may include a second folding surface 1121.

In some demonstrative aspects, a first curvature of the first folding surface 1111 at the particular viewing angle θ may be based, for example, on a reflective optical power of the optical surface 1151 to provide the second reflected light 1174 towards the folding layer 1153 for the particular viewing angle θ.

In some demonstrative aspects, the first curvature of the first folding surface 1111 at the particular viewing angle θ may be based, for example, on a refractive optical power of the refractive surface 1152 to provide the second refracted light 1175 towards the eye 1140 for the particular viewing angle θ.

In some demonstrative aspects, a second curvature of the second folding surface 1121 corresponding to the particular viewing angle θ may be based, for example, on a reflective optical power of the folding layer 1153 to provide the first reflected light 1173 towards the optical surface 1151 for the particular viewing angle θ.

In some demonstrative aspects, the second curvature of the second folding surface 1121 corresponding to the particular viewing angle θ may be based, for example, on a refractive optical power of the optical surface 1151 to provide the first refracted light 1172 towards the folding layer 1153 for the particular viewing angle θ.

In some demonstrative aspects, first folding surface 1111 and/or second folding surface 1121 may be determined, for example, based on a system of equations of thin lenses, which may be applied to the single lens 1110, for example, based on a propagation of a light ray 1160, for example, in a backward ray-tracing.

In some demonstrative aspects, as shown in FIG. 11A, light ray 1160 may propagate from an eye pupil 1141 of the eye 1140 towards the display 1170, for example, in a backward ray-tracing.

In some demonstrative aspects, as shown in FIG. 11A, the light ray 1160 may be refracted by the refractive surface 1152.

In some demonstrative aspects, as shown in FIG. 11A, the light ray 1160 may be reflected by the optical surface 1151.

In some demonstrative aspects, as shown in FIG. 11A, the light ray 1160 may be reflected by the folding layer 1153.

In some demonstrative aspects, as shown in FIG. 11A, the light ray 1160 may be refracted by the optical surface 1151, for example, towards the display 1170.

In some demonstrative aspects, a refraction by a first optical surface, and a following reflection by a second optical surface may be reduced, for example, to a reflection from a first folding surface, for example, based on a system of equations of thin lenses.

In some demonstrative aspects, a reflection by a first optical surface, and a following refraction by a second optical surface may be reduced, for example, to a reflection from a second folding surface, for example, based on the system of equations of thin lenses.

In some demonstrative aspects, as shown in FIGS. 11A and 11B, the refraction of the light ray 1160 by the refractive surface 1152, and the reflection of the light ray 1160 from the optical surface 1151 may be reduced, for example, to a reflection from the first folding surface 1111, e.g., at a point P1.

In some demonstrative aspects, as shown in FIGS. 11A and 11B, the reflection of the light ray 1160 from the folding layer 1153, and the refraction of the light ray 1160 by the optical surface 1151 may be reduced, for example, to a reflection of the light ray 1160 from the second folding surface 1121, e.g., at a point P2.

In some demonstrative aspects, as shown in FIG. 11A and FIG. 11B, catoptric optical mechanism 1002 including only two folding surfaces may be equivalent to optical system 1100, for example, for a light ray 1160, e.g., for any light ray 1160, in optical system 1100, in a direction of a particular viewing angle θ.

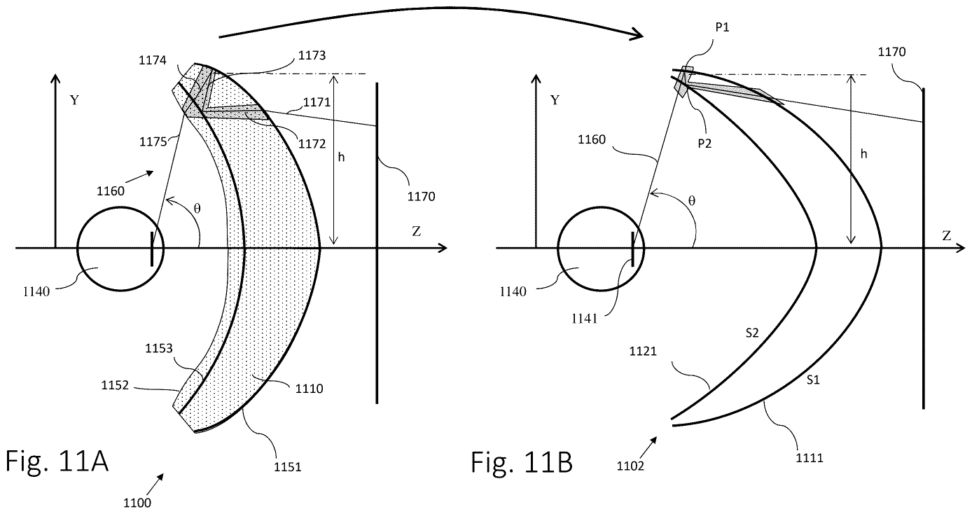

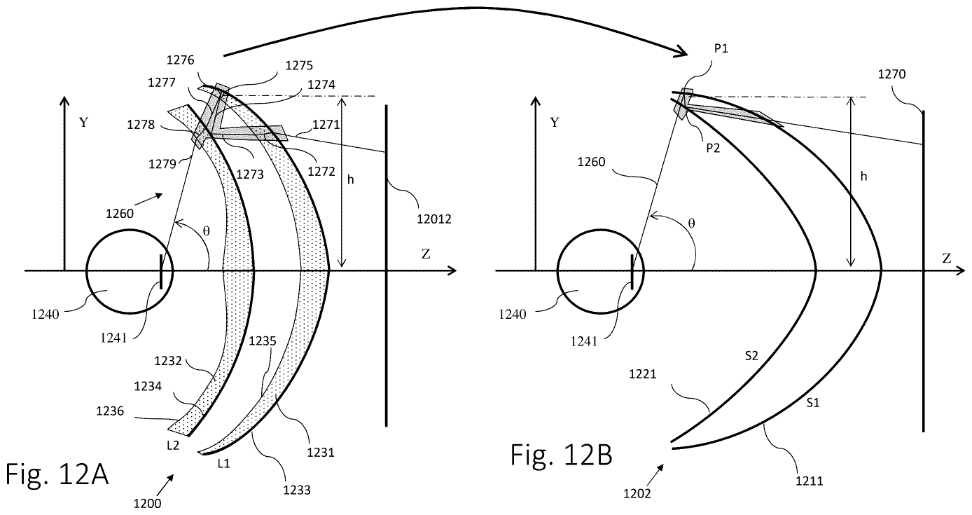

Reference is made to FIG. 12A, which schematically illustrates an optical system 1200, and to FIG. 12B, which schematically illustrates the system 1201 including a catoptric optical mechanism 1202 of the optical system 1200, in accordance with some demonstrative aspects.

For example, system 101 (FIG. 1) and/or optical system 100 (FIG. 1) may include one or more elements of optical system 1200, and/or may be configured to provide at least part of the functionality of optical system 1200.

In some demonstrative aspects, optical system 1200 may be configured to direct light 1271 from a display 1270 to an eye 1240 of a user, for example, according to the catoptric optical mechanism 1202.

In some demonstrative aspects, as shown in FIG. 12A, optical system 1200 may include a display-lens 1231, and an eye-lens 1232.

In some demonstrative aspects, as shown in FIG. 12A, display-lens 1231 may include first display-lens optical surface 1233, e.g., a first light-folding reflective surface.

In some demonstrative aspects, as shown in FIG. 12A, display-lens 1231 may include a second display-lens optical surface 1235, e.g., a first refractive surface, opposite to the first display-lens optical surface 1233.

In some demonstrative aspects, as shown in FIG. 12A, eye-lens 1232 may include a first eye-lens optical surface 1234, e.g., a second light-folding reflective surface.

In some demonstrative aspects, as shown in FIG. 12A, eye-lens 1232 may include a second eye-lens optical surface 1236, e.g., a second refractive surface, opposite to the first eye-lens optical surface 1234.

In one example, optical system 1200 may be a practical configuration, for example, with respect to a manufacturing process of the single lens.

In some demonstrative aspects, optical system 1200 may be configured such that, for example, over at least 20 percent of a FoV of the optical system 1200, a BFL may monotonically decrease with an increase in a viewing angle θ of the eye 1240, e.g., as described above.

In some demonstrative aspects, optical system 1200 may be configured such that, for example, over at least 20 percent of a FoV of the optical system 1200, a number of PPD may monotonically decrease with the increase in the viewing angle θ, e.g., as described above.

In some demonstrative aspects, as shown in FIG. 12A, display-lens 1231 and eye-lens 1232 may be configured to direct the light 1271 from the display to the eye 1240 of the user according to the catoptric optical mechanism 1202, for example, based on refraction of the light 1271 from the display by the first display-lens optical surface 1233, for example, to provide first refracted light 1272 towards the second display-lens optical surface 1233.

In some demonstrative aspects, as shown in FIG. 12A, display-lens 1231 and eye-lens 1232 may be configured to direct the light 1271 from the display to the eye 1240 of the user according to the catoptric optical mechanism 1202, for example, based on refraction of the first refracted light 1272 by the second display-lens optical surface 1235, for example, to provide second refracted light 1273 towards the eye-lens 1232.

In some demonstrative aspects, as shown in FIG. 12A, display-lens 1231 and eye-lens 1232 may be configured to direct the light 1271 from the display to the eye 1240 of the user according to the catoptric optical mechanism 1202, for example, based on reflection of the second refracted light 1273 by the first eye-lens optical surface 1234, for example, to provide first reflected light 1274 towards the display lens 1231.

In some demonstrative aspects, as shown in FIG. 12A, display-lens 1231 and eye-lens 1232 may be configured to direct the light 1271 from the display to the eye 1240 of the user according to the catoptric optical mechanism 1202, for example, based on refraction of the first reflected light 1274 by the second display-lens optical surface 1235, for example, to provide third refracted light 1275, for example, towards the first display-lens optical surface 1233.

In some demonstrative aspects, as shown in FIG. 12A, display-lens 1231 and eye-lens 1232 may be configured to direct the light 1271 from the display to the eye 1240 of the user according to the catoptric optical mechanism 1202, for example, based on reflection of the third refracted light 1275 by the first display-lens optical surface 1233, for example, to provide second reflected light 1276 towards the second display-lens optical surface 1235.

In some demonstrative aspects, as shown in FIG. 12A, display-lens 1231 and eye-lens 1232 may be configured to direct the light 1271 from the display to the eye 1240 of the user according to the catoptric optical mechanism 1202, for example, based on refraction of the second reflected light 1276 by the second display-lens optical surface 1235, for example, to provide fourth refracted light 1277 towards the eye-lens 1232.

In some demonstrative aspects, as shown in FIG. 12A, display-lens 1231 and eye-lens 1232 may be configured to direct the light 1271 from the display to the eye 1240 of the user according to the catoptric optical mechanism 1202, for example, based on refraction of the fourth refracted light 1277 by the first eye-lens optical surface 1234, for example, to provide fifth refracted light 1278 towards the second eye-lens optical surface 1236.

In some demonstrative aspects, as shown in FIG. 12A, display-lens 1231 and eye-lens 1232 may be configured to direct the light 1271 from the display to the eye 1240 of the user according to the catoptric optical mechanism 1202, for example, based on refraction of the fifth refracted light 1278 by the second eye-lens optical surface 1236, for example, to provide sixth refracted light 1279 towards the eye 1240.

In some demonstrative aspects, as shown in FIG. 12B, catoptric optical mechanism 1202 may include a first folding surface 1211.

In some demonstrative aspects, as shown in FIG. 12B, catoptric optical mechanism 1202 may include a second folding surface 1221.

In some demonstrative aspects, a first curvature of the first folding surface 1211 at the particular viewing angle θ may be based, for example, on a refractive optical power of the second display-lens optical surface 1235 to provide the third refracted light 1275 towards the first display-lens optical surface 1233 for the particular viewing angle θ.

In some demonstrative aspects, the first curvature of the first folding surface 1211 at the particular viewing angle θ may be based, for example, on a reflective optical power of the first display-lens optical surface 1233 to provide the second reflected light 1276 towards the second display-lens optical surface 1235 for the particular viewing angle θ.

In some demonstrative aspects, the first curvature of the first folding surface 1211 at the particular viewing angle θ may be based, for example, on a refractive optical power of the second display-lens optical surface 1235 to provide the fourth refracted light 1277 towards the eye-lens 1234 for the particular viewing angle θ.

In some demonstrative aspects, the first curvature of the first folding surface 1211 at the particular viewing angle θ may be based, for example, on a refractive optical power of the first eye-lens optical surface 1234 to provide the fifth refracted light 1278 towards the second eye-lens optical surface 1236 for the particular viewing angle θ.

In some demonstrative aspects, the first curvature of the first folding surface 1211 at the particular viewing angle θ may be based, for example, on a refractive optical power of the second eye-lens optical surface 1236 to provide the sixth refracted light 1279 towards the eye 1240 for the particular viewing angle θ.

In some demonstrative aspects, a second curvature of the second folding surface 1221 corresponding to the particular viewing angle θ may be based, for example, on a refractive optical power of the first display-lens optical surface 1233 to provide the first refracted light 1271 towards the second display-lens optical surface 1235 for the particular viewing angle θ.

In some demonstrative aspects, the second curvature of the second folding surface 1221 corresponding to the particular viewing angle θ may be based, for example, on a refractive optical power of the second display-lens optical surface 1235 to provide the second refracted light 1273 towards the eye-lens 1232 for the particular viewing angle θ.

In some demonstrative aspects, the second curvature of the second folding surface 1221 corresponding to the particular viewing angle θ may be based, for example, on a reflective optical power of the first eye-lens optical surface 1234 to provide the first reflected light 1274 towards the display lens 1231 for the particular viewing angle θ.

In some demonstrative aspects, first folding surface 1211 and/or second folding surface 1221 may be determined, for example, based on the system of equations of thin lenses, which may be applied to the eye-lens 1232 and to the display-lens 1231, for example, based on a propagation of a light ray 1260, for example, in a backward ray-tracing.

In some demonstrative aspects, as shown in FIG. 12A, the light ray 1260 may propagate from an eye pupil 1241 of the eye 1240 towards the display 1270, for example, in a backward ray-tracing.

In some demonstrative aspects, as shown in FIG. 12A, the light ray 1260 may be refracted by the second eye-lens optical surface 1236.

In some demonstrative aspects, as shown in FIG. 12A, the light ray 1260 may be refracted by first eye-lens optical surface 1234.

In some demonstrative aspects, as shown in FIG. 12A, the light ray 1260 may be refracted by the second display-lens optical surface 1235.

In some demonstrative aspects, as shown in FIG. 12A, the light ray 1260 may be reflected by the first display-lens optical surface 1233.

In some demonstrative aspects, as shown in FIG. 12A, the light ray 1260 may be refracted by the second display-lens optical surface 1235.

In some demonstrative aspects, as shown in FIG. 12A, the light ray 1260 may be reflected by the first eye-lens optical surface 1234.

In some demonstrative aspects, as shown in FIG. 12A, the light ray 1260 may be refracted by the second display-lens optical surface 1235.

In some demonstrative aspects, as shown in FIG. 12A, the light ray 1260 may be refracted by the first display-lens optical surface 1233, for example, towards the display 1270.

In some demonstrative aspects, a refraction by a first optical surface and a following reflection by a second optical surface may be reduced, for example, to a reflection from a first folding surface, for example, based on a system of equations of thin lenses.

In some demonstrative aspects, a reflection by a first optical surface and a following refraction by a second optical surface may be reduced, for example, to a reflection from a second folding surface, for example, based on the system of equations of thin lenses.

In some demonstrative aspects, catoptric optical mechanism 1202 may include a simplified version of optical system 1200, which may be determined, for example, based on the system of equations of thin lenses.

In some demonstrative aspects, the display-lens 1231 may perform a functionality of a Mangin mirror, in which the second display-lens optical surface 1235, e.g., a refractive surface, may provide an additional degree of freedom, for example, for correcting optical aberrations.

In some demonstrative aspects, as shown in FIGS. 12A and 12B, the refraction of the light ray 1260 by the eye-lens 1232 and the reflection of the light ray 1260 from the Mangin mirror formed by display-lens 1231 may be reduced, for example, to a reflection of the light ray 1260 from the first folding surface 1211, e.g., at a point P1, for example, based on the system of equations of thin lenses.

In some demonstrative aspects, as shown in FIGS. 12A and 12B, the reflection of the light ray 1260 from the first eye-lens optical surface 1234, the refraction of the light ray 1260 by the first display-lens optical surface 1233, and the refraction of the light ray 1260 by the second display-lens optical surface 1235, may be reduced, e.g., in a similar manner, to a reflection of the light ray 1260 from the second folding surface 1221, e.g., at a point P2.

In some demonstrative aspects, as shown in FIG. 12A and FIG. 12B, the catoptric optical mechanism 1202 including only two folding surfaces, which may be equivalent to optical system 1200, for example, for a light ray 1260, e.g., for any light ray 1260, in optical system 1200, in a direction of a particular viewing angle θ.

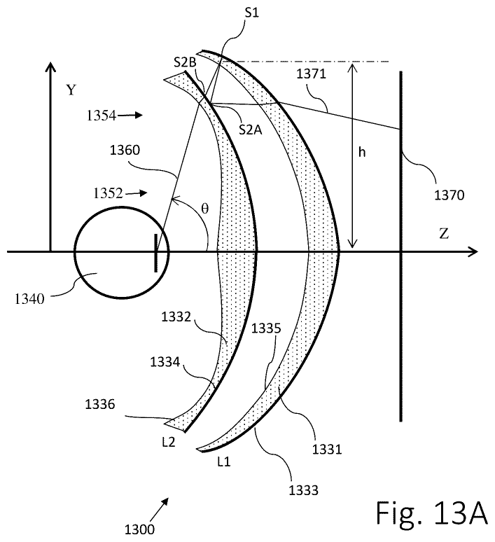

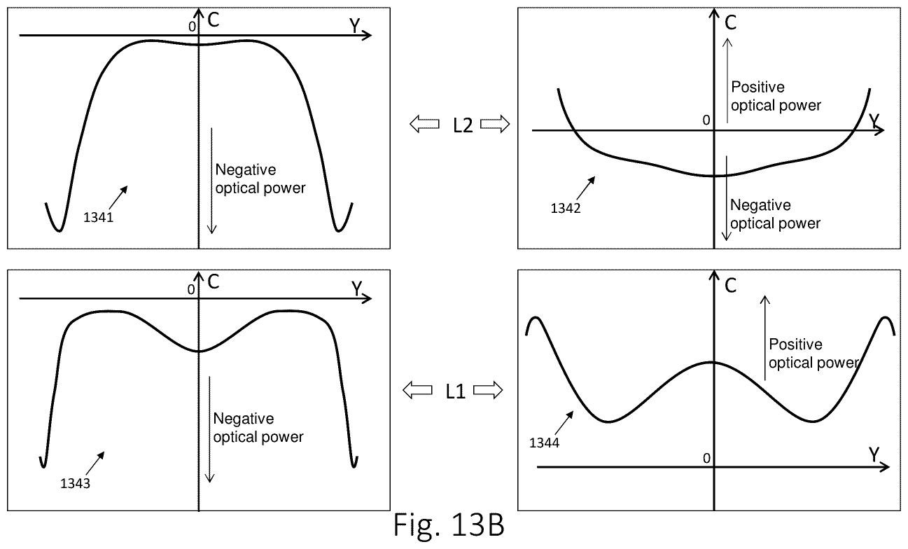

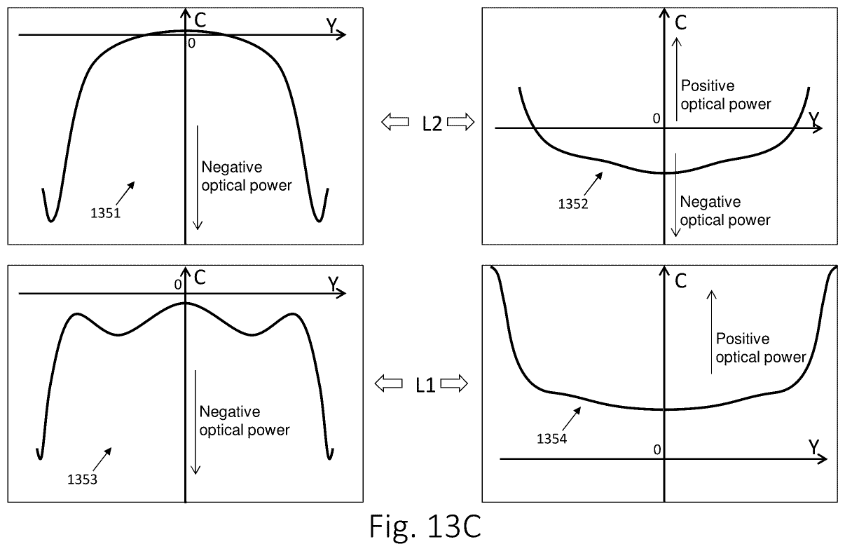

Reference is made to FIG. 13A, which schematically illustrates an optical system 1300, in accordance with some demonstrative aspects.

For example, system 101 (FIG. 1) and/or optical system 100 (FIG. 1) may include one or more elements of optical system 1300, and/or may be configured to provide at least part of the functionality of optical system 1300.

In some demonstrative aspects, optical system 1300 may be configured to direct light 1371 from a display 1370 to an eye 1340 of a user, for example, according to catoptric optical mechanism, e.g., catoptric optical mechanism 102 (FIG. 1).

In some demonstrative aspects, as shown in FIG. 13A, optical system 1300 may include a display-lens 1331, and an eye-lens 1332.

In some demonstrative aspects, as shown in FIG. 13A, display-lens 1331 may include first display-lens optical surface 1333.

In some demonstrative aspects, as shown in FIG. 13A, display-lens 1331 may include a second display-lens optical surface 1335 opposite to the first display-lens optical surface 1333.

In some demonstrative aspects, as shown in FIG. 13A, eye-lens 1332 may include a first eye-lens optical surface 1334.

In some demonstrative aspects, as shown in FIG. 13A, eye-lens 1332 may include a second eye-lens optical surface 1336 opposite to the first eye-lens optical surface 1334.

In some demonstrative aspects, optical system 1300 may be configured such that, for example, over at least 20 percent of a FoV of the optical system 1300, a BFL may monotonically decrease with an increase in a viewing angle θ of the eye 1340, e.g., as described above.

In some demonstrative aspects, optical system 1300 may be configured such that, for example, over at least 20 percent of a FoV of the optical system 1300, a number of PPD may monotonically decrease with the increase in the viewing angle θ, e.g., as described above.

In some demonstrative aspects, as shown in FIG. 13A, a curvature of the second display-lens optical surface 1335 at a peripheral FoV portion 1354 of a FoV of the optical system 1300 may be negative.

In some demonstrative aspects, as shown in FIG. 13A, an absolute value of the curvature of the second display-lens optical surface 1335 at the peripheral FOV portion 1354 may be greater than an absolute value of a curvature of the second display-lens optical surface 1335 at a central FoV portion 1352 of the FoV of the optical system 1300.

In some demonstrative aspects, as shown in FIG. 13A, a curvature of the second eye-lens optical surface 1336 at the peripheral FoV portion 1354 may be negative.

In some demonstrative aspects, as shown in FIG. 13A, an absolute value of the curvature of the second eye-lens optical surface 1336 at the peripheral FoV portion 1354 may be greater than an absolute value of the curvature of the second eye-lens optical surface 1336 at the central FoV portion 1352.

In some demonstrative aspects, as shown in FIG. 13A, the absolute value of the negative curvature of the second display-lens optical surface 1335 may increase at larger values of the viewing angle θ.

In some demonstrative aspects, as shown in FIG. 13A, the absolute value of the negative curvature of the second eye-lens optical surface 1336 may increase at the larger values of the viewing angle θ.

In some demonstrative aspects, optical system 1300 may be configured, for example, such that the increase of the negative curvature of the second display-lens optical surface 1335, and the increase of the negative curvature of the second eye-lens optical surface 1336 at the larger values of the viewing angle θ, may provide a technical solution to support balancing of a high positive curvature of the first display-lens optical surface 1333, for example, at the larger values of the viewing angle θ.

In some demonstrative aspects, optical system 1300 may be configured, for example, such that the high positive curvature of the first display-lens optical surface 1333 at the larger values of the viewing angle θ may provide a technical solution to support folding a light towards an optical axis of the optical system 1300 at high viewing angles, for example, in systems intended for a large FoV.

Reference is made to FIG. 13B, which schematically illustrates first curvatures, which may be implemented by lens surfaces of lenses of the optical system 1300, in accordance with some demonstrative aspects.

In some demonstrative aspects, as shown in FIG. 13B, a graph 1341 depicts a curvature of a lens surface, which may be implemented by the second eye-lens optical surface 1336.

In some demonstrative aspects, as shown in FIG. 13B, a graph 1342 depicts a curvature of a lens surface, which may be implemented by the first eye-lens optical surface 1334.

In some demonstrative aspects, as shown in FIG. 13B, a graph 1343 depicts a curvature of a lens surface, which may be implemented by the second display-lens optical surface 1335.

In some demonstrative aspects, as shown in FIG. 13B, a graph 1344 depicts a curvature of a lens surface, which may be implemented by the first display-lens optical surface 1333.

In some demonstrative aspects, optical system 1300 may implement the first lens surfaces described above with reference to FIG. 13B, for example, to provide a technical solution to support monotonic decrease of a focal length of optical system 1300 with the increase in the viewing angle θ of the eye 1340.

Reference is made to FIG. 13C, which schematically illustrates second curvatures, which may be implemented by lens surfaces of the lenses of the optical system 1300, in accordance with some demonstrative aspects.

In some demonstrative aspects, as shown in FIG. 13C, a graph 1351 depicts a curvature of a lens surface, which may be implemented by the second eye-lens optical surface 1336.

In some demonstrative aspects, as shown in FIG. 13C, a graph 1352 depicts a curvature of a lens surface, which may be implemented by the first eye-lens optical surface 1334.

In some demonstrative aspects, as shown in FIG. 13C, a graph 1353 depicts a curvature of a lens surface, which may be implemented by the second display-lens optical surface 1335.

In some demonstrative aspects, as shown in FIG. 13C, a graph 1354 depicts a curvature of a lens surface, which may be implemented by the first display-lens optical surface 1333.

In some demonstrative aspects, optical system 1300 may implement the second lens surfaces described above with reference to FIG. 13C, for example, to provide a technical solution to support the monotonic decrease of a focal length of optical system 1300 with the increase in the viewing angle θ of the eye 1340.

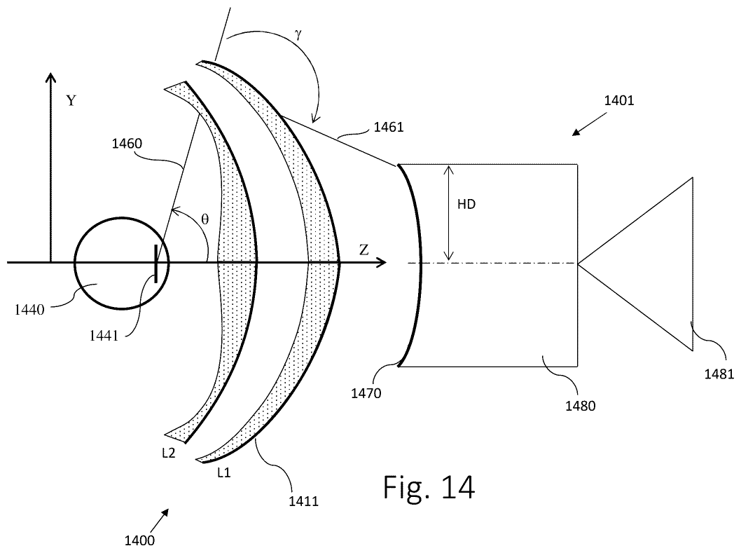

Reference is made to FIG. 14, which schematically illustrates a system 1401 including an optical system 1400 to demonstrate a technical aspect, which may be addressed, in accordance with some demonstrative aspects.

In some demonstrative aspects, system 1401 may include an objective 1481, which may be configured to focus light into system 1401.

In some demonstrative aspects, system 1401 may include a photomultiplier 1480, which may be configured to intensify the light provided by objective 1481.

In some demonstrative aspects, system 1401 may include a display 1470, which may be configured to display images.

In some demonstrative aspects, a display surface of display 1470 may include a planar surface (not shown in FIG. 14).

In some demonstrative aspects, a display surface of display 1470 may include a non-planar surface.

In some demonstrative aspects, the display surface of display 1470 may be concave, convex, or aspherical.

In some demonstrative aspects, as shown in FIG. 14, the display surface of display 1470 may be concave towards the optical system 1400.

In some demonstrative aspects, the display surface of display 1470 may include the non-planar surface, for example, when system 1401 is implemented as a night vision device.

In one example, the non-planar surface of display 1470 may include a phosphorous screen or an output surface of a fiber-optic taper.

In one example, the non-planar surface of the display 1470 may be polished into a certain shape.

For example, as shown in FIG. 14, the non-planar surface of the display 1470 may be polished into a spherical surface, which may be concave towards the optical system 1400.

In some demonstrative aspects, optical system 1400 may be configured to direct light from the display 1470 to an eye 1440 of a user, for example, according to a catoptric optical mechanism, e.g., the catoptric optical mechanism 102 (FIG. 1).

For example, optical system 1400 may include one or more elements of optical system 1300 (FIG. 13), and/or may be configured to provide at least part of the functionality of optical system 1300 (FIG. 1).

As shown in FIG. 14, a chief ray 1460 may include a FoV edge ray, which may be directed to an edge of optical system 1400.

As shown in FIG. 14, the chief ray 1460 may limit a full projected FoV by a FoV angle θ.

As shown in FIG. 14, optical system 1400 may bend the chief ray 1460, e.g., by an angle γ, into a ray 1461, for example, to hit an edge of the display 1470.

As shown in FIG. 14, the smaller a display size of the display 1470, the larger a value of the angle γ, which may be required, for example, to maintain the FoV angle θ.

In one example, large values of the angle γ may be difficult to achieve, for example, as when the value of the angle γ becomes larger, it may be more difficult to compensate optical aberrations and/or to achieve a good image quality with edge-to-edge image clarity and/or a large eye box. According to this example, it may be difficult to achieve a large FoV with a small display, for example, as large values of the angle γ may be required.

As shown in FIG. 14, system 1401 may not be capable to support a large FoV, for example, in case the display size of display 1470 may be limited.

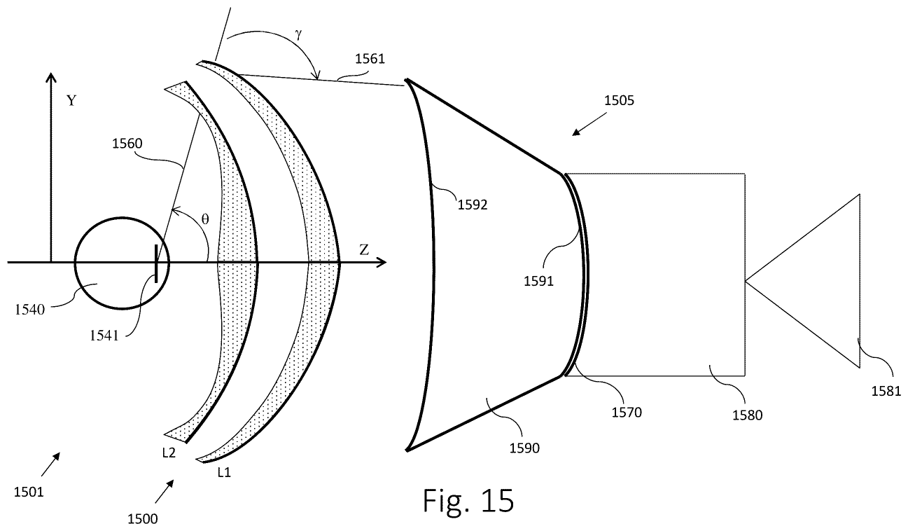

Reference is made to FIG. 15, which schematically illustrates a system 1501 including am optical system 1500, in accordance with some demonstrative aspects.

For example, system 101 (FIG. 1) may include one or more elements of system 1501, and/or may be configured to provide at least part of the functionality of system 1501; and/or optical system 100 (FIG. 1) may include one or more elements of optical system 1500, and/or may be configured to provide at least part of the functionality of optical system 1500.

In some demonstrative aspects, system 1501 may include a night vision device 1505.

In some demonstrative aspects, night vision device 1505 may include an objective 1581, which may be configured to focus light into system 1501.

In some demonstrative aspects, the night vision device 1505 may include a photomultiplier 1580, which may be configured to intensify the light provided by objective 1581.

In some demonstrative aspects, the night vision device 1505 may include a display 1570, which may be configured to display images.

In some demonstrative aspects, the night vision device 1505 may include the optical system 1500.

In some demonstrative aspects, optical system 1500 may be configured to direct light from the display 1570 to an eye 1540 of a user, for example, according to a catoptric optical mechanism, e.g., the catoptric optical mechanism 102 (FIG. 1).

For example, optical system 1500 may include one or more elements of optical system 1300 (FIG. 13), and/or may be configured to provide at least part of the functionality of optical system 1300 (FIG. 1).

In some demonstrative aspects, as shown in FIG. 15, a fiber optic taper 1590 may be implemented between the display 1570 and the optical system 1500.

In some demonstrative aspects, as shown in FIG. 15, the fiber optic taper 1590 may include a first surface 1591 facing the display 1570.

In some demonstrative aspects, as shown in FIG. 15, the fiber optic taper 1590 may include a second surface 1592 facing the optical system 1500.

In some demonstrative aspects, as shown in FIG. 15, an area of the second surface 1592 may be greater than an area of the first surface 1591.

In some demonstrative aspects, as shown in FIG. 15, the fiber optic taper 1590 may be utilized to “move” the display surface from the surface 1570 to the surface 1592.

In some demonstrative aspects, as shown in FIG. 15, the fiber optic taper 1590 may expand the display size.

In some demonstrative aspects, as shown in FIG. 15, the first surface 1591 may be closer, e.g., as close as possible, to a display surface 1571 of the display 1570 of the night vision device 1505.

In some demonstrative aspects, surface 1591 and the display surface 1571 may be at an optical contact, for example, through an optical adhesive.

In one example, the surface 1592 may be spherical, e.g., concave, convex, aspherical, or freeform.

In some demonstrative aspects, the surface 1592 may be polished to a certain shape, for example, to provide a technical solution to support compensation of a field curvature of the optical system 1500, and/or to balance optical aberrations of the optical system 1500.

In some demonstrative aspects, as shown in FIG. 15, a chief ray 1560 may be a FoV edge ray of optical system 1500.

In some demonstrative aspects, as shown in FIG. 15, optical system 1500 may bend the chief ray 1560 by an angle γ into a ray 1561, for example, to hit an edge of the surface 1592.

In some demonstrative aspects, as shown in FIG. 15, a size of the angle γ may be smaller, for example, than a size of the angle γ in FIG. 14.

In some demonstrative aspects, system 1501 may be configured to include the fiber optic taper 1590, for example, to provide a technical solution to support a large FoV, for example, even with a small display size of display 1570, for example, to maintain a relatively small value of the angle γ, e.g., which may not limit the FoV.

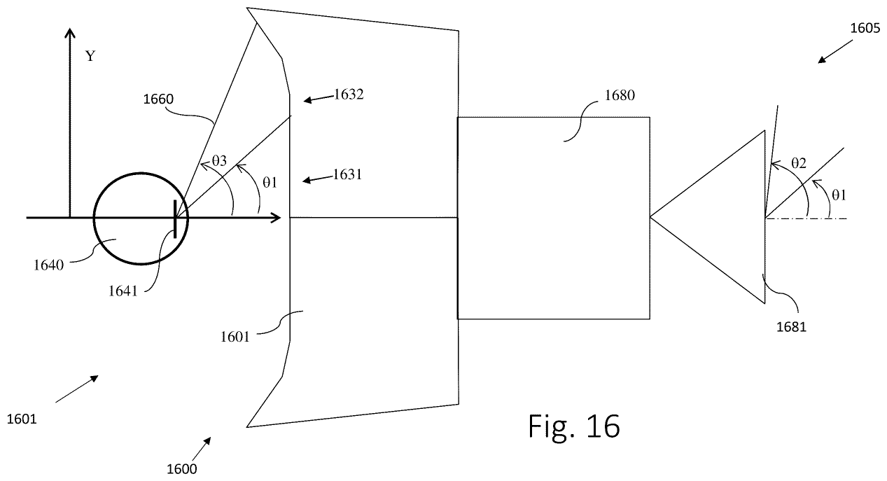

Reference is made to FIG. 16, which schematically illustrates a system 1601 including an optical system 1600, in accordance with some demonstrative aspects.

For example, system 101 (FIG. 1) may include one or more elements of system 1601, and/or may be configured to provide at least part of the functionality of system 1601; and/or optical system 100 (FIG. 1) may include one or more elements of optical system 1600, and/or may be configured to provide at least part of the functionality of optical system 1600.

In some demonstrative aspects, system 1601 may include a night vision device 1605.

In some demonstrative aspects, night vision device 1605 may include an objective 1681, which may be configured to focus light into system 1601.

In some demonstrative aspects, the night vision device 1605 may include a photomultiplier 1680, which may be configured to intensify the light provided by objective 1681.

In some demonstrative aspects, optical system 1600 may include an integrated optical system, which may be integrated with one or more elements of the night vision device 1605.

In some demonstrative aspects, the integrated optical system 1600 may be configured to direct light from photomultiplier 1680 to an eye 1640 of a user.

In some demonstrative aspects, as shown in FIG. 16, the objective 1681 may support a maximum FoV, for example, up to a FoV angle θ2.

In some demonstrative aspects, optical system 1600 may support a maximum FoV, for example, up to a FoV angle θ3.

In one example, the maximum FoV (FoV angle θ3) of optical system 1600 may be lower than the maximum FoV (FoV angle θ2) of the objective, e.g., θ3<θ2. According to this example, one or more objects, which may be located between FoV angle θ2 and FoV angle θ3 may not be displayed to the user, for example, if distortion compensation is not applied, e.g., as described below.

In some demonstrative aspects, a FoV of optical system 1600 may include a central FoV portion 1631, and a peripheral FoV portion 1632.

In some demonstrative aspects, the central FoV portion 1631 may correspond to a central gaze of the eye 1640.

In some demonstrative aspects, the central FOV portion 1631 may include a portion of the FoV of optical system 1600 between a viewing angle θ and a FoV angle θ1.

In some demonstrative aspects, the peripheral FoV portion may correspond to a peripheral gaze of the eye 1640.

In some demonstrative aspects, the peripheral FoV portion 1632 may include a portion of the FoV of optical system 1600 between the FoV angle θ1 and the FoV angle θ3.

In some demonstrative aspects, optical system 1600 may be configured, for example, such that a distortion of the optical system 1600 at the peripheral FoV portion 1632 may be greater than a distortion of the optical system 1600 at the central FoV portion 1631.

In some demonstrative aspects, the distortion of the optical system 1600 at the central FoV portion 1631 may be configured to be substantially opposite to a distortion of the objective 1681 of the optical system 1600 at the central FoV portion 1631, for example, to provide a technical solution to compensate the distortion of the objective 1681 at the central FoV portion 1631.

In some demonstrative aspects, optical system 1600 may be configured, for example, such that the distortion of the optical system 1600 may be designed to have a strong distortion at the peripheral FoV portion 1632, e.g., a strong barrel distortion, for example, to provide a technical solution to support vision from a larger FoV of the objective 1681, e.g., up to the FoV angle θ2, for example, for situational awareness.

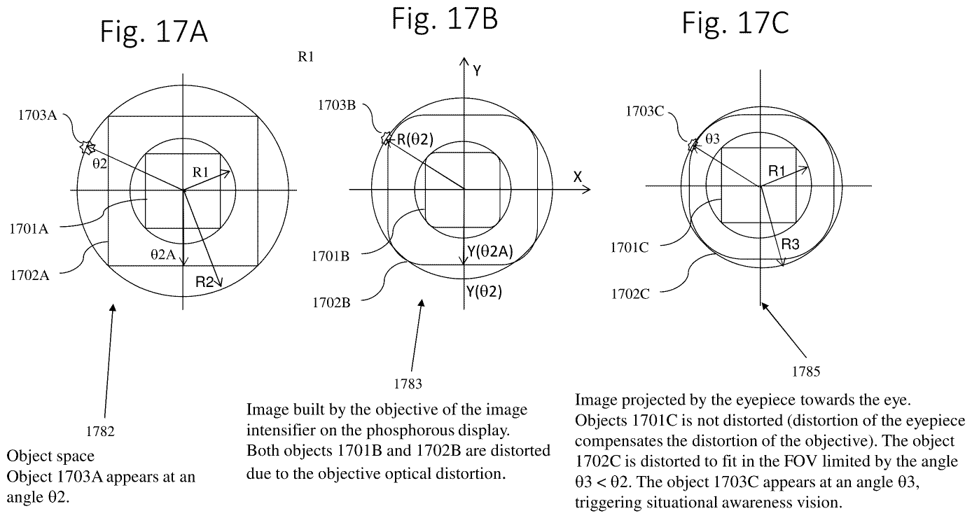

Reference is made to FIGS. 17A, 17B, and 17C, which schematically illustrate a distortion compensation scheme 1700 to demonstrate a distortion compensation of an optical system, in accordance with some demonstrative aspects.

In one example, FIGS. 17A, 17B and 17C may demonstrate the distortion compensation of optical system 1600 (FIG. 16), for example, to compensate for the distortion of the objective 1600 (FIG. 16) at the central FoV portion 1631 (FIG. 16).

In some demonstrative aspects, as shown in FIG. 17A, an image 1782 may include a square object 1701A, a square object 1702A, and a star object 1703A, e.g., in an angular space.

In one example, image 1782 may represent the angular space projected by the optical system 1600 (FIG. 16) towards the eye 1640 (FIG. 16).

In some demonstrative aspects, as shown in FIG. 17A, the square object 1701A may be inscribed in a circle having a radius R1.

In some demonstrative aspects, as shown in FIG. 17A, the square object 1702A may be inscribed in a circle having a radius R2.

In some demonstrative aspects, as shown in FIG. 17A, the star object 1703A may be located at an angle θ2 from the FoV center.

In some demonstrative aspects, as shown in FIG. 17B, an image 1783 may represent the images of the objects from the FIG. 17A on a display of an image intensifier, e.g., display 1570 (FIG. 15) and/or display 1470 (FIG. 14).

In one example, the image 1783 may be in an XY coordinate space. For example, the XY coordinate space may represent a plane, which may coincide with a display plane of display 1570 (FIG. 15).

In some demonstrative aspects, as shown in FIG. 17B, the square object 1701A, the square object 1702A, and the star object 1703A may be displayed by the display as a square object 1701B, a square object 1702B, and a star object 1703B, respectively.

In some demonstrative aspects, as shown in FIG. 17B, the square object 1701B, the square object 1702B, and the star object 1703B may be distorted, for example, by a distortion of an objective, e.g., objective 1681 (FIG. 16).

In some demonstrative aspects, the optical system 1600 (FIG. 16) may be configured to compensate for the distortion of the objective at the central FoV portion 1631 (FIG. 16).

In some demonstrative aspects, as shown in FIG. 17C, an image 1785 may represent the images of the objects from the FIG. 17A, for example, after compensation of the distortion of the objective by optical system 1600 (FIG. 16) at the central FoV portion 1631 (FIG. 16).

In some demonstrative aspects, as shown in FIG. 17C, image 1785 may include a square object 1701C, a square object 1702C, and a star object 1703C, for example, after the compensation of the distortion of the objective at the central FoV portion 1631 (FIG. 16).

In some demonstrative aspects, as shown in FIG. 17C, the square image 1701A, which is located at the central FoV portion 1631 (FIG. 16), may be projected undistorted, e.g., as square image 1701C.

In some demonstrative aspects, the optical system 1600 (FIG. 16) may be configured to increase the distortion of the objective at the peripheral FOV portion 1633 (FIG. 16), e.g., from the FoV angle θ1.

In some demonstrative aspects, as shown in FIG. 17C, the square image 1702C, which is located at the peripheral FoV portion 1633 (FIG. 16), may have a greater distortion, for example, compared to the square image 1702B.

In some demonstrative aspects, as shown in FIG. 17C, the star image 1703C, which is located at the peripheral FOV portion 1633 (FIG. 16), may have a greater distortion, for example, compared to the star image 1703B.

In some demonstrative aspects, as shown in FIG. 17C, the star image 1703A may be projected as star image 1703C at a FoV angle θ3, which may be less than the FoV angle θ2, in the angular space. However, the exact position of the star image 1703C may not be important, as it may be enough to project the star image 1703C in the peripheral vision, e.g., in order to trigger situational awareness.

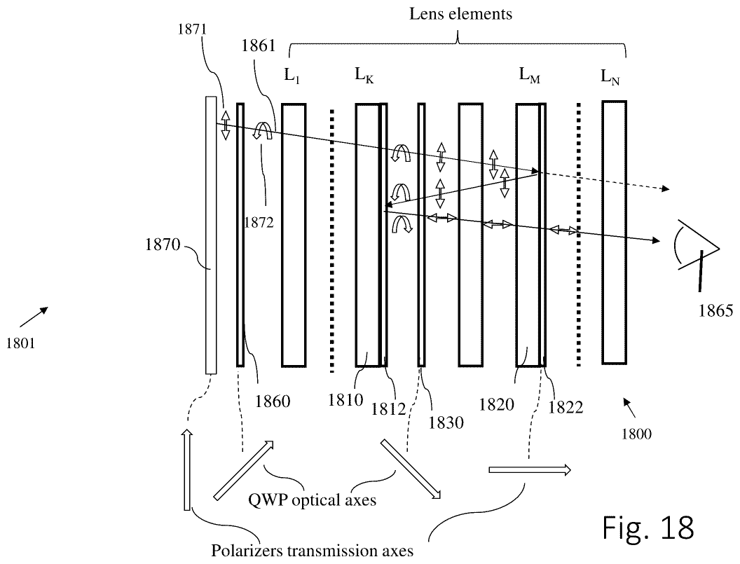

Reference is now made to FIG. 18, which schematically illustrates a system 1801 including an optical system 1802, in accordance with some demonstrative aspects.

For example, system 101 (FIG. 1) may include one or more elements of system 1801, and/or may be configured to provide at least part of the functionality of system 1801; and/or optical system 100 (FIG. 1) may include one or more elements of optical system 1800, and/or may be configured to provide at least part of the functionality of optical system 1800.

In some demonstrative aspects, optical system 1800 may be configured to direct light from a display 1870 to an eye 1865 of a user, for example, according to a catoptric optical mechanism, e.g., catoptric optical mechanism 102 (FIG. 1).

In some demonstrative aspects, optical system 1800 may include a catadioptric system including a plurality of lenses, for example, including N lenses, denoted L₁-L_{N}, e.g., ten lenses or any other number of lenses.

In some demonstrative aspects, optical system 1800 may include a first lens 1810, denoted L_{K}, which may include a semi-reflective surface 1812, e.g., implemented by a beamsplitter coating.

In some demonstrative aspects, as shown in FIG. 18, optical system 1800 may include a second lens 1820, denoted L_{M}, which may include a reflective polarizer surface 1822, e.g., implemented by a linear polarizer.

In some demonstrative aspects, as shown in FIG. 18, optical system 1800 may include a retarder 1830, e.g., a Quarter Wave Plate (QWP) retarder or any other retarder, between the first lens 1810 and the second lens 1820.

In some demonstrative aspects, the retarder 1830 and the reflective polarizer surface 1822 may be combined, for example, into a single optical element, e.g., a circular reflective polarizer.

In some demonstrative aspects, as shown in FIG. 18, the light from the display 1870 may be folded by the semi-reflective surface 1812, the reflective polarizer surface 1822, and the retarder 1830.

In some demonstrative aspects, as shown in FIG. 18, system 1801 may include a lens-display retarder 1860 between the display 1870 and the semi-reflective surface 1812.

In some demonstrative aspects, lens-display retarder 1860 may be configured to convert a polarization of the light from the display 1870 into a circular polarization to be transferred by the semi-reflective surface 1812.

In some demonstrative aspects, as shown in FIG. 18, lens-display retarder 1860 may be configured to convert light 1861 from the display 1870 having a linear polarization 1871 into light having a first handedness circular polarization 1872.

In some demonstrative aspects, an optical axis of the retarder 1830 may be orthogonal to an optical axis of the lens-display retarder 1860.

In some demonstrative aspects, the retarder 1830 and the lens-display retarder 1860 may have substantially identical optical configurations.

In some demonstrative aspects, as shown in FIG. 18, system 1801 may be configured to support a folded light path, for example, by applying a polarization control, e.g., based on the reflective polarizer surface 1822.

In some demonstrative aspects, as shown in FIG. 18, system 1801 may include the display 1870, the set of lenses L1-LN, two Quarter Wave Plate (QWP) retarders, e.g., the retarder 1830 and the lens-display retarder 1860, a semi-reflective mirror, e.g., semi-reflective surface 1812 on the surface of the lens L_{K}, and a reflecting polarizer, e.g., reflective polarizer surface 1822 on the surface of the lens L_{M}.

### Examples

The following examples pertain to further aspects.

Example 1 includes an apparatus comprising an optical system configured to direct light from a display to an eye of a user according to a catoptric optical mechanism, the catoptric optical mechanism comprising a first folding surface; and a second folding surface, wherein at least one of the first folding surface or the second folding surface comprises an aspherical surface, wherein the first folding surface is configured to transfer the light from the display towards the second folding surface, and to reflect light from the second folding surface towards the eye, wherein the second folding surface is configured to reflect the light from the display towards the first folding surface, and to transfer reflected light from the first folding surface towards the eye, wherein the first folding surface and the second folding surface are configured such that, over at least 20 percent of a Field of View (FoV) of the optical system, a Back Focal Length (BFL) monotonically decreases with an increase in a viewing angle of the eye, wherein the BFL corresponding to a particular viewing angle comprises a distance between the second folding surface and a field curvature surface corresponding to the particular viewing angle, wherein the field curvature surface corresponding to the particular viewing angle is based on a first curvature of the first folding surface at the particular viewing angle and a second curvature of the second folding surface corresponding to the particular viewing angle.

Example 2 includes the subject matter of Example 1, and optionally, wherein the field curvature surface corresponding to the particular viewing angle is convex towards the eye.

Example 3 includes the subject matter of Example 1 or 2, and optionally, wherein the field curvature surface corresponding to the particular viewing angle is convex towards the eye for any viewing angle in at least 20 percent of the FoV of the optical system.

Example 4 includes the subject matter of any one of Examples 1-3, and optionally, wherein the field curvature surface corresponding to the particular viewing angle is centered at an optical axis of the optical system.

Example 5 includes the subject matter of any one of Examples 1-4, and optionally, wherein the field curvature surface corresponding to the particular viewing angle comprises a Petzval surface.

Example 6 includes the subject matter of any one of Examples 1-5, and optionally, wherein the field curvature surface corresponding to the particular viewing angle comprises a virtual field curvature surface formed by a first virtual optical surface having the first curvature and a second virtual optical surface having the second curvature.

Example 7 includes the subject matter of any one of Examples 1-6, and optionally, wherein the first folding surface and the second folding surface are configured such that a curvature of a system field curvature surface corresponding to the optical system is based on a curvature of a display surface of the display.

Example 8 includes the subject matter of Example 7, and optionally, wherein the system field curvature surface is formed by a plurality of points on a plurality of field curvature surfaces, the plurality of field curvature surfaces corresponding to a plurality of viewing angles, wherein a point of the plurality of points comprises an intersection between the particular viewing angle and the field curvature surface.

Example 9 includes the subject matter of any one of Examples 1-8, and optionally, wherein the first curvature of the first folding surface at the particular viewing angle comprises a curvature of the first folding surface at a portion of the first folding surface to reflect light from the second folding surface towards the eye at the particular viewing angle.

Example 10 includes the subject matter of any one of Examples 1-9, and optionally, wherein the second curvature of the second folding surface corresponding to the particular viewing angle comprises a curvature of the second folding surface at a portion of the second folding surface to reflect towards the first folding surface the light from the display to be provided to the eye at the particular viewing angle.

Example 11 includes the subject matter of any one of Examples 1-10, and optionally, wherein the BFL corresponding to the particular viewing angle is based on a distance between a first intersection point and a second intersection point along an optical axis of the optical system, wherein the first intersection point comprises an intersection between the optical axis and the second folding surface, the second intersection point comprises an intersection between the optical axis and the field curvature surface corresponding to the particular viewing angle.

Example 12 includes the subject matter of any one of Examples 1-11, and optionally, wherein the first folding surface and the second folding surface are configured such that a first BFL corresponding to a first viewing angle is longer than a second BFL corresponding to a second viewing angle, wherein the second viewing angle is greater than the first viewing angle.

Example 13 includes the subject matter of any one of Examples 1-12, and optionally, wherein the first folding surface and the second folding surface are configured such that, over at least 20 percent of the FoV of the optical system, a total focal length of the optical system monotonically decreases with the increase in the viewing angle of the eye.

Example 14 includes the subject matter of Example 13, and optionally, wherein a value of the total focal length corresponding to the particular viewing angle is based on a first focal length and a second focal length, wherein the first focal length is based on the first curvature, and the second focal length is based on the second curvature.

Example 15 includes the subject matter of any one of Examples 1-14, and optionally, wherein the first folding surface is configured such that a focal length of the first folding surface is positive for any viewing angle in at least 20 percent of the FoV of the optical system.

Example 16 includes the subject matter of any one of Examples 1-15, and optionally, wherein the second folding surface is configured such that a focal length of the second folding surface is negative for any viewing angle in at least 20 percent of the FoV of the optical system.

Example 17 includes the subject matter of any one of Examples 1-16, and optionally, wherein the first folding surface and the second folding surface are configured such that, for any particular viewing angle in at least 20 percent of the FoV of the optical system, an absolute value of a first focal length is less than an absolute value of a second focal length, wherein the first focal length is based on the first curvature, and the second focal length is based on the second curvature.

Example 18 includes the subject matter of any one of Examples 1-17, and optionally, wherein the first folding surface and the second folding surface are configured such that, over at least 20 percent of the FoV of the optical system, a number of Pixels Per Degree (PPD) of the optical system monotonically decreases with the increase in the viewing angle of the eye.

Example 19 includes the subject matter of any one of Examples 1-18, and optionally, wherein the viewing angle of the eye comprises an angle between an optical axis of the optical system and a line between a center of a pupil of the eye to a point on the first folding surface.

Example 20 includes the subject matter of any one of Examples 1-19, and optionally, wherein the aspherical surface is configured such that, over at least 20 percent of the FoV of the optical system, a curvature of the aspherical surface monotonically increases with the increase in the viewing angle of the eye.

Example 21 includes the subject matter of any one of Examples 1-19, and optionally, wherein the aspherical surface is configured such that, over at least 20 percent of the FoV of the optical system, a curvature of the aspherical surface monotonically decreases with the increase in the viewing angle of the eye.

Example 22 includes the subject matter of any one of Examples 1-19, and optionally, wherein the aspherical surface comprises an axis portion and an edge portion, the axis portion between an optical axis of the optical system and an inflection point on the aspherical surface, the edge portion between the inflection point and an edge of the optical system, wherein the aspherical surface is configured such that a curvature of one portion of the edge portion or the axis portion is positive over at least 20 percent of the one portion, and a curvature of an other portion of the edge portion or the axis portion is negative over at least 20 percent of the other portion.

Example 23 includes the subject matter of any one of Examples 1-22, and optionally, wherein the first folding surface comprises the aspherical surface, and the second folding surface comprises a spherical surface.

Example 24 includes the subject matter of Example 23, and optionally, wherein the first folding surface is configured such that, over at least 20 percent of the FoV of the optical system, a curvature of the first folding surface monotonically increases with the increase in the viewing angle of the eye.

Example 25 includes the subject matter of any one of Examples 1-22, and optionally, wherein the first folding surface comprises a spherical surface, and the second folding surface comprises the aspherical surface.

Example 26 includes the subject matter of Example 25, and optionally, wherein the second folding surface is configured such that, over at least 20 percent of a first range of viewing angles between an optical axis of the optical system and an inflection point on the second folding surface, a curvature of the second folding surface is negative and monotonically increasing with the increase in the viewing angle of the eye, and such that, over at least 20 percent of a second range of viewing angles between the inflection point and an edge of the optical system, the curvature of the second folding surface is positive and monotonically increasing with the increase in the viewing angle of the eye.

Example 27 includes the subject matter of Example 25, and optionally, wherein the second folding surface is configured such that, over at least 20 percent of the FoV of the optical system, a curvature of the second folding surface is negative and monotonically increasing with the increase in the viewing angle of the eye.

Example 28 includes the subject matter of any one of Examples 1-22, and optionally, wherein the first folding surface comprises a first aspherical surface, and the second folding surface comprises a second aspherical surface.

Example 29 includes the subject matter of Example 28, and optionally, wherein the first folding surface is configured such that, over at least 20 percent of the FOV of the optical system, a curvature of the first folding surface monotonically increases with the increase in the viewing angle of the eye, wherein the second folding surface is configured such that, over at least 20 percent of a first range of viewing angles between an optical axis of the optical system and an inflection point on the second folding surface, a curvature of the second folding surface is negative and monotonically increasing with the increase in the viewing angle of the eye, and such that, over at least 20 percent of a second range of viewing angles between the inflection point and an edge of the optical system, the curvature of the second folding surface is positive and monotonically increasing with the increase in the viewing angle of the eye.

Example 30 includes the subject matter of Example 28, and optionally, wherein the first folding surface is configured such that, over at least 20 percent of the FoV of the optical system, a curvature of the first folding surface monotonically increases with the increase in the viewing angle of the eye, and wherein the second folding surface is configured such that, over at least 20 percent of the FoV of the optical system, a curvature of the second folding surface is negative and monotonically increasing with the increase in the viewing angle of the eye.

Example 31 includes the subject matter of Example 28, and optionally, wherein the first folding surface is configured such that, over at least 20 percent of the FoV of the optical system, a curvature of the first folding surface is positive and may monotonically decrease with the increase in the viewing angle of the eye, wherein the second folding surface is configured such that, over at least 20 percent of the FoV of the optical system, a curvature of the second folding surface is negative and monotonically increasing with the increase in the viewing angle of the eye.

Example 32 includes the subject matter of Example 31, and optionally, wherein an increase rate of the curvature of the second folding surface is greater than a decrease rate of the curvature of the first folding surface.

Example 33 includes the subject matter of Example 28, and optionally, wherein the first folding surface is configured such that, over at least 20 percent of a first range of viewing angles between an optical axis of the optical system and a first inflection point on the first folding surface, a curvature of the first folding surface is positive and may monotonically decrease with the increase in the viewing angle of the eye, and such that, over at least 20 percent of a second range of viewing angles between the first inflection point and an edge of the optical system, the curvature of the first folding surface is negative and monotonically decreasing with the increase in the viewing angle of the eye, wherein the second folding surface is configured such that, over at least 20 percent of a third range of viewing angles between the optical axis of the optical system and a second inflection point on the second folding surface, a curvature of the second folding surface is negative and monotonically increasing with the increase in the viewing angle of the eye, and such that, over at least 20 percent of a fourth range of viewing angles between the second inflection point and the edge of the optical system, the curvature of the second folding surface is positive and monotonically increasing with the increase in the viewing angle of the eye.

Example 34 includes the subject matter of Example 33, and optionally, wherein a rate of a change in the curvature of the first folding surface is greater than a rate of a change in the curvature of the second folding surface.

Example 35 includes the subject matter of any one of Examples 1-34, and optionally, wherein the optical system comprises a semi-reflective mirror to provide the first folding surface; and a reflective polarizer to provide the second folding surface.

Example 36 includes the subject matter of Example 35, and optionally, wherein the reflective polarizer comprises a circular reflective polarizer comprising a single optical element, or a linear reflective polarizer combined with a quarter-wave optical retarder.

Example 37 includes the subject matter of any one of Examples 1-34, and optionally, wherein the optical system comprises a single lens comprising a first optical surface; and a second optical surface opposite to the first optical surface, wherein the first optical surface and the second optical surface are configured to direct the light from the display to the eye of the user according to the catoptric optical mechanism based on refraction of the light from the display by the first optical surface to provide first refracted light towards the second optical surface; reflection of the first refracted light by the second optical surface to provide first reflected light towards the first optical surface; reflection of the first reflected light by the first optical surface to provide second reflected light towards the second optical surface; and refraction of the second reflected light by the second optical surface to provide second refracted light towards the eye.

Example 38 includes the subject matter of Example 37, and optionally, wherein the first curvature of the first folding surface at the particular viewing angle is based on a reflective optical power of the first optical surface to provide the second reflected light towards the second optical surface for the particular viewing angle, and based on a refractive optical power of the second optical surface to provide the second refracted light towards the eye for the particular viewing angle.

Example 39 includes the subject matter of Example 37 or 38, and optionally, wherein the second curvature of the second folding surface corresponding to the particular viewing angle is based on a reflective optical power of the second optical surface to provide the first reflected light towards the first optical surface for the particular viewing angle, and based on a refractive optical power of the first optical surface to provide the first refracted light towards the second optical surface for the particular viewing angle.

Example 40 includes the subject matter of any one of Examples 1-34, and optionally, wherein the optical system comprises a single lens comprising an optical surface; a refractive surface opposite to the optical surface; and a folding layer between the optical surface and the refractive surface, wherein the single lens is configured to direct the light from the display to the eye of the user according to the catoptric optical mechanism based on refraction of the light from the display by the optical surface to provide first refracted light towards the folding layer; reflection of the first refracted light by the folding layer to provide first reflected light towards the optical surface; reflection of the first reflected light by the optical surface to provide second reflected light towards the folding layer; transfer of the second reflected light by the folding layer towards the refractive surface; and refraction of the second reflected light by the refractive surface to provide second refracted light towards the eye.

Example 41 includes the subject matter of Example 40, and optionally, wherein the first curvature of the first folding surface at the particular viewing angle is based on a reflective optical power of the optical surface to provide the second reflected light towards the folding layer for the particular viewing angle, and based on a refractive optical power of the refractive surface to provide the second refracted light towards the eye for the particular viewing angle.

Example 42 includes the subject matter of Example 40 or 41, and optionally, wherein the second curvature of the second folding surface corresponding to the particular viewing angle is based on a reflective optical power of the folding layer to provide the first reflected light towards the optical surface for the particular viewing angle, and based on a refractive optical power of the first optical surface to provide the first refracted light towards the folding layer for the particular viewing angle.

Example 43 includes the subject matter of any one of Examples 1-34, and optionally, wherein the optical system comprises an eye-lens comprising first display-lens optical surface, and a second display-lens optical surface opposite to the first optical surface; and a display lens comprising a first eye-lens optical surface, and a second eye-lens optical surface opposite to the first optical surface, wherein the display-lens and the eye-lens are configured to direct the light from the display to the eye of the user according to the catoptric optical mechanism based on refraction of the light from the display by the first display-lens optical surface to provide first refracted light towards the second display-lens optical surface; refraction of the first refracted light by the second display-lens optical surface to provide second refracted light towards the eye-lens; reflection of the second refracted light by the first eye-lens optical surface to provide first reflected light towards the display lens; refraction of the first reflected light by the second display-lens optical surface to provide third refracted light towards the first display-lens optical surface; reflection of the third refracted light by the first display-lens optical surface to provide second reflected light towards the second display-lens optical surface; refraction of the second reflected light by the second display-lens optical surface to provide fourth refracted light towards the eye-lens; refraction of the fourth refracted light by the first eye-lens optical surface to provide fifth refracted light towards the second eye-lens optical surface; and refraction of the fifth refracted light by the second eye-lens optical surface to provide sixth refracted light towards the eye.

Example 44 includes the subject matter of Example 43, and optionally, wherein the first curvature of the first folding surface at the particular viewing angle is based on a refractive optical power of the second display-lens optical surface to provide the third refracted light towards the first display-lens optical surface for the particular viewing angle, based on a reflective optical power of the first display-lens optical surface to provide the second reflected light towards the second display-lens optical surface for the particular viewing angle, based on a refractive optical power of the second display-lens optical surface to provide the fourth refracted light towards the eye-lens for the particular viewing angle, based on a refractive optical power of the first eye-lens optical surface to provide the fifth refracted light towards the second eye-lens optical surface for the particular viewing angle, and based on a refractive optical power of the second eye-lens optical surface to provide the sixth refracted light towards the eye for the particular viewing angle.

Example 45 includes the subject matter of Example 43 or 44, and optionally, wherein the second curvature of the second folding surface corresponding to the particular viewing angle is based on a refractive optical power of the first display-lens optical surface to provide the first refracted light towards the second display-lens optical surface for the particular viewing angle, based on a refractive optical power of the second display-lens optical surface to provide the second refracted light towards the eye-lens for the particular viewing angle, and based on a reflective optical power of the first eye-lens optical surface to provide the first reflected light towards the display lens for the particular viewing angle.

Example 46 includes the subject matter of any one of Examples 43-45, and optionally, wherein a curvature of the second display-lens optical surface at a peripheral FoV portion of the FoV of the optical system is negative, wherein an absolute value of the curvature of the second display-lens optical surface at the peripheral FoV portion is greater than an absolute value of a curvature of the second display-lens optical surface at a central FoV portion of the FoV of the optical system, wherein a curvature of the second eye-lens optical surface at the peripheral FoV portion is negative, wherein an absolute value of the curvature of the second display-lens optical surface at the peripheral FoV portion is greater than an absolute value of a curvature of the second eye-lens optical surface at the central FoV portion, the central FoV portion corresponding to a central gaze of the eye, the peripheral FoV portion corresponding to a peripheral gaze of the eye.

Example 47 includes the subject matter of any one of Examples 1-46, and optionally, wherein the first folding surface and the second folding surface are configured such that, over at least 30 percent of the FoV of the optical system, the BFL monotonically decreases with the increase in the viewing angle of the eye.

Example 48 includes the subject matter of any one of Examples 1-47, and optionally, wherein the first folding surface and the second folding surface are configured such that, over at least 50 percent of the FoV of the optical system, the BFL is monotonically decreases with the increase in the viewing angle of the eye.

Example 49 includes the subject matter of any one of Examples 1-48, and optionally, wherein the first folding surface and the second folding surface are configured such that, over at least 55 percent of the FoV of the optical system, the BFL is monotonically decreases with the with the increase in the viewing angle of the eye.

Example 50 includes the subject matter of any one of Examples 1-49, and optionally, comprising a fiber optic taper between the display and the optical system.

Example 51 includes the subject matter of Example 50, and optionally, wherein the fiber optic taper comprises a first surface facing the display and a second surface facing the optical system, wherein an area of the second surface is greater than an area of the first surface.

Example 52 includes the subject matter of any one of Examples 1-51, and optionally, wherein the optical system is configured such that a distortion of the optical system at a peripheral FoV portion of the FoV of the optical system is greater than a distortion of the optical system at a central FoV portion of the FoV of the optical system, the central FoV portion corresponding to a central gaze of the eye, the peripheral FOV portion corresponding to a peripheral gaze of the eye.

Example 53 includes the subject matter of Example 52, and optionally, wherein the distortion of the optical system at the central FoV portion is opposite to a distortion of an objective of the optical system at the central FoV portion.

Example 54 includes the subject matter of any one of Examples 1-53, and optionally, comprising a night vision device comprising an objective; a photomultiplier; the display; and the optical system.

Example 55 includes a device comprising a display; a controller to control images to be displayed by the display; and the apparatus of any one of Examples 1-54.

Example 56 includes a Head Mounted Display (HMD) device comprising a display; a controller to control images to be displayed by the display; and the apparatus of any one of Examples 1-54.

Example 57 includes an apparatus comprising means for performing any of the described operations of Examples 1-54.

Example 58 includes a method comprising any of the described operations of Examples 1-54.

Functions, operations, components, and/or features described herein with reference to one or more aspects, may be combined with, or may be utilized in combination with, one or more other functions, operations, components, and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. An apparatus comprising:
an optical system configured to direct light from a display to an eye of a user according to a catoptric optical mechanism, the catoptric optical mechanism comprising:
a first folding surface; and
a second folding surface, wherein at least one of the first folding surface or the second folding surface comprises an aspherical surface,
wherein the first folding surface is configured to transfer the light from the display towards the second folding surface, and to reflect light from the second folding surface towards the eye, wherein the second folding surface is configured to reflect the light from the display towards the first folding surface, and to transfer reflected light from the first folding surface towards the eye,
wherein the first folding surface and the second folding surface are configured such that, over at least 20 percent of a Field of View (FoV) of the optical system, a Back Focal Length (BFL) monotonically decreases with an increase in a viewing angle of the eye, wherein the BFL corresponding to a particular viewing angle comprises a distance between the second folding surface and a field curvature surface corresponding to the particular viewing angle, wherein the field curvature surface corresponding to the particular viewing angle is based on a first curvature of the first folding surface at the particular viewing angle and a second curvature of the second folding surface corresponding to the particular viewing angle.

2. The apparatus of claim 1, wherein the field curvature surface corresponding to the particular viewing angle is convex towards the eye.

3. The apparatus of claim 1, wherein the field curvature surface corresponding to the particular viewing angle is convex towards the eye for any viewing angle in at least 20 percent of the FoV of the optical system.

4. The apparatus of claim 1, wherein the field curvature surface corresponding to the particular viewing angle is centered at an optical axis of the optical system.

5. The apparatus of claim 1, wherein the field curvature surface corresponding to the particular viewing angle comprises a Petzval surface.

6. The apparatus of claim 1, wherein the field curvature surface corresponding to the particular viewing angle comprises a virtual field curvature surface formed by a first virtual optical surface having the first curvature and a second virtual optical surface having the second curvature.

7. The apparatus of claim 1, wherein the first folding surface and the second folding surface are configured such that a curvature of a system field curvature surface corresponding to the optical system is based on a curvature of a display surface of the display.

8. The apparatus of claim 7, wherein the system field curvature surface is formed by a plurality of points on a plurality of field curvature surfaces, the plurality of field curvature surfaces corresponding to a plurality of viewing angles, wherein a point of the plurality of points comprises an intersection between the particular viewing angle and the field curvature surface.

9. The apparatus of claim 1, wherein the BFL corresponding to the particular viewing angle is based on a distance between a first intersection point and a second intersection point along an optical axis of the optical system, wherein the first intersection point comprises an intersection between the optical axis and the second folding surface, the second intersection point comprises an intersection between the optical axis and the field curvature surface corresponding to the particular viewing angle.

10. The apparatus of claim 1, wherein the first folding surface and the second folding surface are configured such that a first BFL corresponding to a first viewing angle is longer than a second BFL corresponding to a second viewing angle, wherein the second viewing angle is greater than the first viewing angle.

11. The apparatus of claim 1, wherein the first folding surface and the second folding surface are configured such that, over at least 20 percent of the FoV of the optical system, a total focal length of the optical system monotonically decreases with the increase in the viewing angle of the eye.

12. The apparatus of claim 1, wherein the first folding surface is configured such that a focal length of the first folding surface is positive for any viewing angle in at least 20 percent of the FoV of the optical system.

13. The apparatus of claim 1, wherein the second folding surface is configured such that a focal length of the second folding surface is negative for any viewing angle in at least 20 percent of the FoV of the optical system.

14. The apparatus of claim 1, wherein the first folding surface and the second folding surface are configured such that, for any particular viewing angle in at least 20 percent of the FoV of the optical system, an absolute value of a first focal length is less than an absolute value of a second focal length, wherein the first focal length is based on the first curvature, and the second focal length is based on the second curvature.

15. The apparatus of claim 1, wherein the first folding surface and the second folding surface are configured such that, over at least 20 percent of the FoV of the optical system, a number of Pixels Per Degree (PPD) of the optical system monotonically decreases with the increase in the viewing angle of the eye.

16. The apparatus of claim 1, wherein the aspherical surface is configured such that, over at least 20 percent of the FoV of the optical system, a curvature of the aspherical surface monotonically increases with the increase in the viewing angle of the eye.

17. The apparatus of claim 1, wherein the aspherical surface comprises an axis portion and an edge portion, the axis portion between an optical axis of the optical system and an inflection point on the aspherical surface, the edge portion between the inflection point and an edge of the optical system, wherein the aspherical surface is configured such that a curvature of one portion of the edge portion or the axis portion is positive over at least 20 percent of the one portion, and a curvature of an other portion of the edge portion or the axis portion is negative over at least 20 percent of the other portion.

18. The apparatus of claim 1, wherein the first folding surface comprises the aspherical surface, and the second folding surface comprises a spherical surface.

19. The apparatus of claim 1, wherein the first folding surface comprises a spherical surface, and the second folding surface comprises the aspherical surface.

20. The apparatus of claim 19, wherein the second folding surface is configured such that, over at least 20 percent of a first range of viewing angles between an optical axis of the optical system and an inflection point on the second folding surface, a curvature of the second folding surface is negative and monotonically increasing with the increase in the viewing angle of the eye, and such that, over at least 20 percent of a second range of viewing angles between the inflection point and an edge of the optical system, the curvature of the second folding surface is positive and monotonically increasing with the increase in the viewing angle of the eye.

21. The apparatus of claim 1, wherein the first folding surface comprises a first aspherical surface, and the second folding surface comprises a second aspherical surface.

22. The apparatus of claim 21, wherein the first folding surface is configured such that, over at least 20 percent of the FoV of the optical system, a curvature of the first folding surface monotonically increases with the increase in the viewing angle of the eye,
wherein the second folding surface is configured such that, over at least 20 percent of a first range of viewing angles between an optical axis of the optical system and an inflection point on the second folding surface, a curvature of the second folding surface is negative and monotonically increasing with the increase in the viewing angle of the eye, and such that, over at least 20 percent of a second range of viewing angles between the inflection point and an edge of the optical system, the curvature of the second folding surface is positive and monotonically increasing with the increase in the viewing angle of the eye.

23. The apparatus of claim 21, wherein the first folding surface is configured such that, over at least 20 percent of the FoV of the optical system, a curvature of the first folding surface monotonically increases with the increase in the viewing angle of the eye, and
wherein the second folding surface is configured such that, over at least 20 percent of the FoV of the optical system, a curvature of the second folding surface is negative and monotonically increasing with the increase in the viewing angle of the eye.

24. The apparatus of claim 21, wherein the first folding surface is configured such that, over at least 20 percent of the FoV of the optical system, a curvature of the first folding surface is positive, wherein the second folding surface is configured such that, over at least 20 percent of the FoV of the optical system, a curvature of the second folding surface is negative and monotonically increasing with the increase in the viewing angle of the eye.

25. The apparatus of claim 1, wherein the optical system comprises:
a semi-reflective mirror to provide the first folding surface; and
a reflective polarizer to provide the second folding surface.

26. The apparatus of claim 1, wherein the optical system comprises a single lens comprising:
a first optical surface; and
a second optical surface opposite to the first optical surface,
wherein the first optical surface and the second optical surface are configured to direct the light from the display to the eye of the user according to the catoptric optical mechanism based on:
refraction of the light from the display by the first optical surface to provide first refracted light towards the second optical surface;
reflection of the first refracted light by the second optical surface to provide first reflected light towards the first optical surface;
reflection of the first reflected light by the first optical surface to provide second reflected light towards the second optical surface; and
refraction of the second reflected light by the second optical surface to provide second refracted light towards the eye.

27. The apparatus of claim 1, wherein the optical system comprises a single lens comprising:
an optical surface;
a refractive surface opposite to the optical surface; and
a folding layer between the optical surface and the refractive surface,
wherein the single lens is configured to direct the light from the display to the eye of the user according to the catoptric optical mechanism based on:
refraction of the light from the display by the optical surface to provide first refracted light towards the folding layer;
reflection of the first refracted light by the folding layer to provide first reflected light towards the optical surface;
reflection of the first reflected light by the optical surface to provide second reflected light towards the folding layer;
transfer of the second reflected light by the folding layer towards the refractive surface; and
refraction of the second reflected light by the refractive surface to provide second refracted light towards the eye.

28. The apparatus of claim 1, wherein the optical system comprises:
an eye-lens comprising first display-lens optical surface, and a second display-lens optical surface opposite to the first optical surface; and
a display lens comprising a first eye-lens optical surface, and a second eye-lens optical surface opposite to the first optical surface,
wherein the display-lens and the eye-lens are configured to direct the light from the display to the eye of the user according to the catoptric optical mechanism based on:
refraction of the light from the display by the first display-lens optical surface to provide first refracted light towards the second display-lens optical surface;
refraction of the first refracted light by the second display-lens optical surface to provide second refracted light towards the eye-lens;
reflection of the second refracted light by the first eye-lens optical surface to provide first reflected light towards the display lens;
refraction of the first reflected light by the second display-lens optical surface to provide third refracted light towards the first display-lens optical surface;
reflection of the third refracted light by the first display-lens optical surface to provide second reflected light towards the second display-lens optical surface;
refraction of the second reflected light by the second display-lens optical surface to provide fourth refracted light towards the eye-lens;
refraction of the fourth refracted light by the first eye-lens optical surface to provide fifth refracted light towards the second eye-lens optical surface; and
refraction of the fifth refracted light by the second eye-lens optical surface to provide sixth refracted light towards the eye.

29. The apparatus of claim 1 comprising a fiber optic taper between the display and the optical system, wherein the fiber optic taper comprises a first surface facing the display and a second surface facing the optical system, wherein an area of the second surface is greater than an area of the first surface.

30. The apparatus of claim 1 comprising a night vision device comprising:
an objective;
a photomultiplier;
the display; and
the optical system.
